(19) United States
(12) Patent Application Publication
(10) Pub. No.: US 2017/0195889 A1
(43) Pub. Date: Jul. 6, 2017

(54) RADIO BASE STATION, USER TERMINAL AND RADIO COMMUNICATION METHOD

(71) Applicant: NTT DOCOMO, INC., Tokyo (JP)

(72) Inventors: Kazuki Takeda, Tokyo (JP); Hiroki Harada, Tokyo (JP); Satoshi Nagata, Tokyo (JP); Jing Wang, Beijing (CN); Liu Liu, Beijing (CN); Huiling Jiang, Beijing (CN)

(73) Assignee: NTT DOCOMO, INC., Tokyo (JP)

(21) Appl. No.: 15/325,359

(22) PCT Filed: Jun. 24, 2015
(86) PCT No.: PCT/JP2015/068209

§ 371 Date: Jan. 10, 2017

(30) Foreign Application Priority Data
Jul. 11, 2014 (JP) 2014-143218

(51) Int. Cl. H04W 16/14; H04W 72/04

(52) U.S. Cl. CPC H04W 16/14; H04W 72/0446

(57) ABSTRACT

The present invention is designed to prevent the deterioration of communication quality even when LBT is used in a radio communication system that runs LTE/LTE-A and/or the like in an unlicensed band. A radio base station communicates with a user terminal that can use a licensed band and an unlicensed band, and has a transmission section that transmits a plurality of DL signals in the unlicensed band, and a control section that controls the transmissions of the DL signals in the unlicensed band based on the results of LBT (Listen Before Talk), and the control section control section controls the transmission of part of the DL signals among the plurality of DL signals without applying LBT. To be more specific, the control section configures the transmission cycle of a DL signal that is transmitted without applying LBT longer than the transmission cycle that is applied in an existing system.

### TECHNICAL FIELD

The present invention relates to a radio base station, a user terminal and a radio communication method that are applicable to next-generation communication systems.

### BACKGROUND ART

In the UMTS (Universal Mobile Telecommunications System) network, the specifications of long term evolution (LTE) have been drafted for the purpose of further increasing high speed data rates, providing lower delays and so on (see non-patent literature 1). In LTE, as multiple-access schemes, a scheme that is based on OFDMA (Orthogonal Frequency Division Multiple Access) is used in downlink channels (downlink), and a scheme that is based on SC-FDMA (Single Carrier Frequency Division Multiple Access) is used in uplink channels (uplink). Also, successor systems of LTE (referred to as, for example, “LTE-advanced” or “LTE enhancement” (hereinafter referred to as “LTE-A”)) have been developed for the purpose of achieving further broadbandization and increased speed beyond LTE, and the specifications thereof have been drafted (Re. 10/11).

In the LTE-A system, a HetNet (Heterogeneous Network), in which small cells (for example, pico cells, femto cells and so on) each having a local coverage area of a radius of approximately several tens of meters are formed within a macro cell having a wide coverage area of a radius of approximately several kilometers, is under study. Also, in relationship to HetNets, a study is in progress to use carriers of different frequency bands between macro cells (macro base stations) and small cells (small base stations), in addition to carriers of the same frequency band.

Furthermore, for future radio communication systems (Rel. 12 and later versions), a system (“LTE-U” (LTE Unlicensed) to run LTE systems not only in frequency bands licensed to communications providers (operators) (licensed bands), but also in frequency bands where license is not required (unlicensed bands), is under study. In particular, a system that runs unlicensed bands on the premise of licensed bands (LAA: Licensed-Assisted Access) is also under study. Note that systems that run LTE/LTE-A in unlicensed bands may be collectively referred to as “LAA.” A licensed band is a band in which a specific provider is allowed exclusive use, and an unlicensed band is a band which is not limited to a specific provider and in which radio stations can be provided.

For unlicensed bands, for example, the 2.4 GHz band and the 5 GHz band where Wi-Fi and Bluetooth (registered trademark) can be used, the 60 GHz band where millimeter-wave radars can be used, and so on are under study for use. Studies are in progress to use such unlicensed bands in small cells.

### CITATION LIST

### Non-Patent Literature

Non-Patent Literature 1: 3GPP TS 36. 300 “Evolved UTRA and Evolved UTRAN Overall Description”

### SUMMARY OF INVENTION

### Technical Problem

Existing LTE presumes operation in licensed bands, and therefore each operator is allocated a different frequency band. However, unlike a licensed band, an unlicensed band is not limited to use by a specific provider. Furthermore, unlike a licensed band, an unlicensed band is not limited to use in a specific radio system (for example, LTE, Wi-Fi, etc.). Consequently, there is a possibility that the frequency band which a given operator uses in LAA overlaps the frequency band which another operator uses in LAA and/or Wi-Fi.

An unlicensed band may be run without even synchronization, coordination and/or cooperation between different operators and/or non-operators. Furthermore, different operators and/or non-operators may set up radio access points (also referred to as “APs,” “TPs,” etc.) and/or radio base stations (eNBs) without even coordinating and/or cooperating with each other. In this case, detailed cell planning is not possible, and interference control is not possible, and therefore there is a threat that significant cross-interference is produced in the unlicensed band, unlike a licensed band.

Consequently, when an LBT/LTE-A system (LTE-U) is run in an unlicensed band, it is desirable if the LBT/LTE-A system operates by taking into account the cross-interference with other systems that run in this unlicensed band, such as Wi-Fi, LTE-U under other operators, and so on. In order to prevent cross-interference in unlicensed bands, a study is in progress to allow an LTE-U base station/user terminal to perform “listening” before transmitting a signal and check whether other base stations/user terminals are communicating. This listening operation is also referred to as “LBT” (Listen Before Talk).

However, when an LTE-U base station/user terminal controls transmissions (for example, determines whether or not a transmission is possible) based on LBT results, there is a threat that the transmissions of signals are limited depending on the results of LBT, and it might occur that signals cannot be transmitted at predetermined timings. In this case, signal delays, signal disconnections or cell detection failures occur in LTE-U, resulting in a deterioration of signal quality.

The present invention has been made in view of the above, and it is therefore an object of the present invention to provide a radio base station, a user terminal and a radio communication method, which can prevent the deterioration of communication quality even when LBT is used in a radio communication system that runs LTE/LTE-A and/or the like in an unlicensed band.

### Solution to Problem

One aspect of the present invention provides a radio base station that communicates with a user terminal that can use a licensed band and an unlicensed band, and this radio base station has a transmission section that transmits a plurality of DL signals in the unlicensed band, and a control section that controls transmission of the DL signals in the unlicensed band based on results of LBT (Listen Before Talk), and, in this radio base station, the control section controls transmission of part of the DL signals among the plurality of DL signals without applying LBT.

### Advantageous Effects of Invention

According to one aspect of the present invention, it is possible to prevent the deterioration of communication quality even when LBT is used in a radio communication system that runs LTE/LTE-A and/or the like in an unlicensed band.

### BRIEF DESCRIPTION OF DRAWINGS

FIG. 1 provide diagrams to show examples of modes of operation when LTE is used in an unlicensed band;

FIG. 2 is a diagram to show an example of a mode of operation when LTE is used in an unlicensed band;

FIG. 3 is a diagram to show examples of LBT-exempt signals, which are configured per LAA system operation mode;

FIG. 4 is a diagram to show example of allocation of DL signals in an existing system;

FIG. 5 provide diagrams to show examples of transmission cycles configured with DL signals that serve as LBT-exempt signals;

FIG. 6 is a diagram to show an example of an allocation method of PBCH signals that serve as LBT-exempt signals;

FIG. 7 is a diagram to show examples of allocation methods of DL signals that serve as LBT-exempt signals;

FIG. 8 is a diagram to show other examples of allocation methods of DL signals that serve as LBT-exempt signals;

FIG. 9 is a diagram to show examples of LBT-exempt signals that are configured per LAA system operation mode;

FIG. 10 is a diagram to show an example of allocation of UL signals (SRS and PRACH) an in existing system;

FIG. 11 is a diagram to show an example of allocation of a UL signal (PUCCH) in an existing system;

FIG. 12 is a diagram to show examples of allocation methods of UL signals that serve as LBT-exempt signals;

FIG. 13 is a diagram to show other examples of allocation methods of UL signals that serve as LBT-exempt signals;

FIG. 14 is a schematic diagram to show an example of a radio communication system according to the present embodiment;

FIG. 15 is a diagram to explain an overall structure of a radio base station according to the present embodiment;

FIG. 16 is a diagram to explain a functional structure of a radio base station according to the present embodiment;

FIG. 17 is a diagram to explain an overall structure of a user terminal according to the present embodiment; and

FIG. 18 is a diagram to explain a functional structure of a user terminal according to the present embodiment.

### DESCRIPTION OF EMBODIMENTS

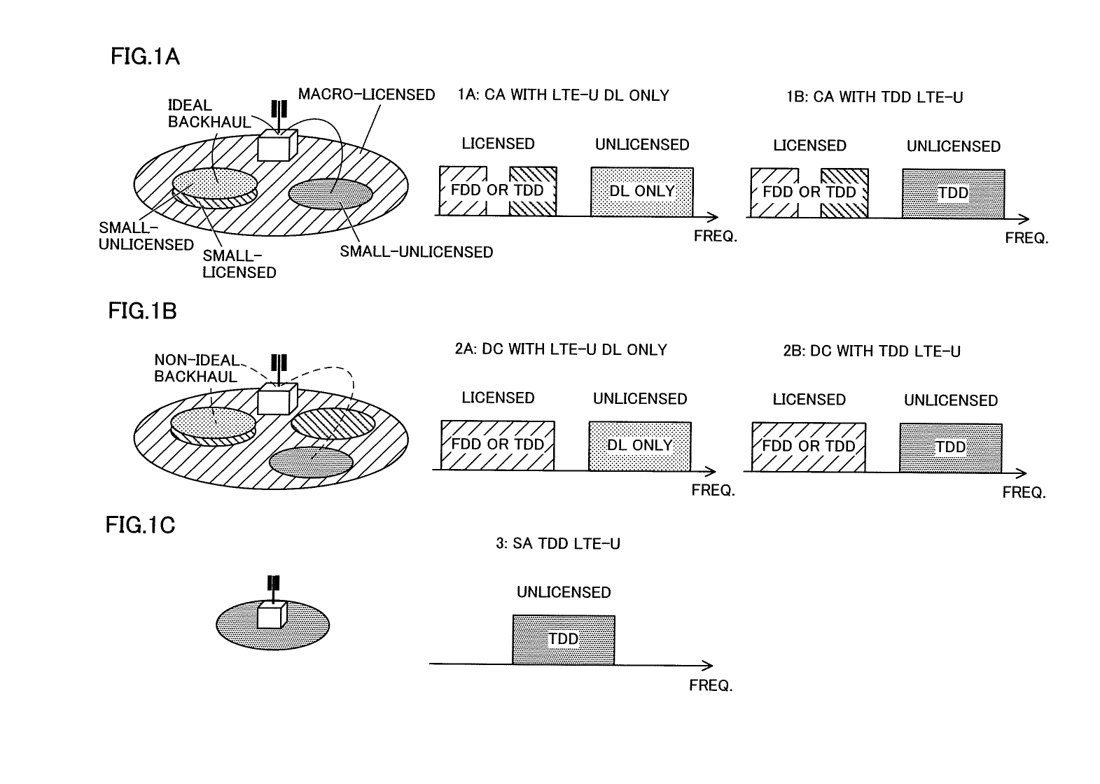

FIG. 1 show examples of operation modes of a radio communication system (LTE-U) that runs LTE in an unlicensed band. As shown in FIG. 1, a plurality of scenarios such as carrier aggregation (CA), dual connectivity (DC) and stand-alone (SA) are possible scenarios to use LTE in an unlicensed band.

FIG. 1A shows a scenario to employ carrier aggregation (CA) by using a licensed band and an unlicensed band. CA is a technique to bundle a plurality of frequency blocks (also referred to as “component carriers” (CCs), “cells,” etc.) into a wide band. Each CC has, for example, a maximum 20 MHz bandwidth, so that, when maximum five CCs are bundled, a wide band of maximum 100 MHz is provided.

With the example shown in FIG. 1A, a case is illustrated in which a macro cell and/or a small cell to use licensed bands and small cells to use unlicensed bands employ CA. When CA is employed, one radio base station's scheduler controls the scheduling of a plurality of CCs. Based on this, CA may be referred to as “intra-base station CA” (intra-eNB CA) as well.

In this case, a small cell to use an unlicensed band may use a carrier that is used for DL communication only (scenario 1A) or use TDD (scenario 1B). The carrier to use for DL communication only is also referred to as a “supplemental downlink” (SDL). Note that FDD and/or TDD can be used in licensed bands.

Furthermore, a (co-located) structure may be employed here in which a licensed band an unlicensed band can be transmitted and received via one transmitting/receiving point (for example, a radio base station). In this case, the transmitting/receiving point (for example, an LTE/LTE-U base station) can communicate with a user terminal by using both the licensed band and the unlicensed band. Alternatively, it is equally possible to employ a (non-co-located) structure to transmit and receive a licensed band and an unlicensed band via different transmitting/receiving points (for example, one via a radio base station and the other one via an RRH (Remote Radio Head) that is connected with the radio base station).

FIG. 1B show a scenario to employ dual connectivity (DC) by using a licensed band and an unlicensed band. DC is the same as CA in bundling a plurality of CCs (or cells) into a wide band. While CA is based on the premise that CCs (or cells) are connected via ideal backhaul and is therefore capable of coordinated control, which produces very little delay time, DC presumes cases in which cells are connected via non-ideal backhaul, which produces delay time that is more than negligible.

Consequently, in dual connectivity, cells are run by separate base stations, and user terminals communicate by connecting with cells (or CCs) of varying frequencies that are run under different base stations. So, when dual connectivity is employed, a plurality of schedulers are provided individually, and these multiple schedulers each control the scheduling of one or more cells (CCs) managed thereunder. Based on this, dual connectivity may be referred to as “inter-base station CA” (inter-eNB CA). Note that, in dual connectivity, carrier aggregation (intra-eNB CA) may be employed per individual scheduler (that is, base station) that is provided.

The example shown in FIG. 1B illustrates a case where a macro cell to use a licensed band and a small cell to use an unlicensed band employ DC. In this case, the small cell to use an unlicensed band may use a carrier for exclusive use for DL communication (scenario 2A), or use TDD (scenario 2B). Note that the macro cell to use a licensed band can use FDD and/or TDD.

In the example shown in FIG. 1C, stand-alone is employed, in which a cell to run LTE by using an unlicensed band operates alone. Stand-alone here means that communication with terminals is possible without employing CA or DC. In scenario 3, the unlicensed band can be run in a TDD band.

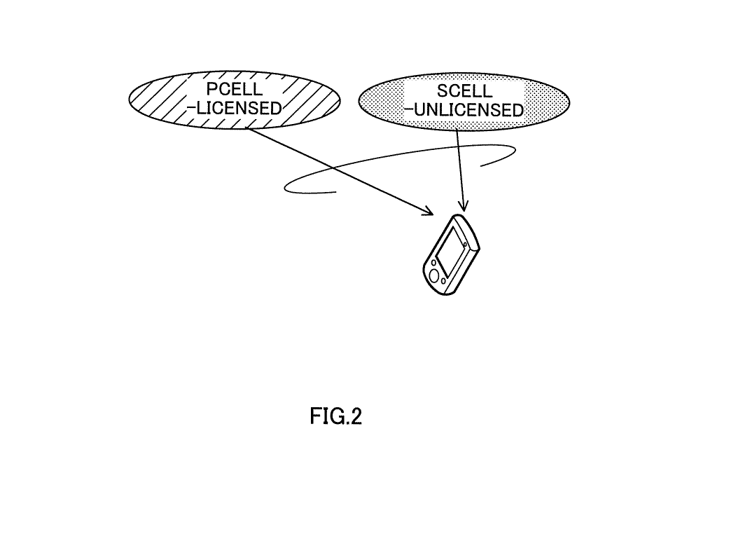

In the operation modes of CA and DC shown in FIG. 1A and FIG. 1B, for example, it is possible to use the licensed band CC (macro cell) as the primary cell (PCell) and use an unlicensed band CC (small cell) as a secondary cell (SCell) (see FIG. 2). Here, the primary cell (PCell) refers to the cell that manages RRC connection, handover and so on when CA/DC is used, and is also a cell that requires UL communication in order to receive data and feedback signals from terminals. The primary cell is always configured in the uplink and the downlink. A secondary cell (SCell) is another cell that is configured in addition to the primary cell when CA/DC is employed. Secondary cells may be configured in the downlink alone, or may be configured in both the uplink and the downlink at the same time.

Note that, as shown in above FIG. 1A (CA) and FIG. 1B (DC), a mode to presume the presence of licensed-band LTE (licensed LTE) when running LTE-U is referred to as “LAA” (Licensed-Assisted Access) or “LAA-LTE.” In LAA, licensed band LTE and unlicensed band LTE coordinate to allow communication with user terminals. LAA may assume a structure, in which a transmission point to use a licensed band (for example, a radio base station) and a transmission point to use an unlicensed band, when being a distance apart, are connected via a backhaul link (for example, optical fiber, the X2 interface and so on).

Now, existing LTE presumes operation in licensed bands, and therefore each operator is allocated a different frequency band. However, unlike a licensed band, an unlicensed band is not limited to use by a specific provider. When run in an unlicensed band, LTE may be carried out without even synchronization, coordination and/or cooperation between different operators and/or non-operators. In this case, a plurality of operators and/or systems share and use the same frequency in the unlicensed band, and therefore there is a threat of producing cross-interference.

So, in Wi-Fi systems that are run in unlicensed bands, carrier sense multiple access/collision avoidance (CSMA/CA), which is based on the mechanism of LBT (Listen Before Talk), is employed. To be more specific, for example, a method, whereby each transmission point (TP), access point (AP), Wi-Fi terminal (STA: Station) and so on perform “listening” (CCA: Clear Channel Assessment) before carrying out transmission, and carries out transmission only when there is no signal beyond a predetermined level, is used. When there is a signal to exceed a predetermined level, a waiting time is provided, which is determined on a random basis, and, following this, listening is performed again.

So, for LTE/LTE-A systems (for example, LAA) that are run in unlicensed bands, too, a study is in progress to use transmission control that employs LBT (Listen Before Talk), as in Wi-Fi systems.

For example, an LTE-U base station and/or a user terminal perform listening (LBT) before transmitting signals in an unlicensed band cell, and checks whether communication is in progress in other systems (for example, Wi-Fi) and/or LTE-U under other operators. If, as a result of listening, no signal from other systems and/or other LAA transmission points is detected, the LTE-U base station and/or the user terminal transmit signals. On the other hand, if signals from other systems and/or other LAA transmission points are detected as a result of listening, the LTE-U base station and/or the user terminal limit the transmission of signals. The transmission of signals is limited by, for example, making a transition to another carrier by way of DFS (Dynamic Frequency Selection), applying transmission power control (TPC) or stopping signal transmission.

In this way, when LBT is applied to communication in an LTE/LTE-A system (for example, LAA) that runs in an unlicensed band, it becomes possible to reduce interference with other systems and so on. However, the present inventors have found out that applying LBT to all the signal transmission operations in LTE/LTE-A communication that runs in an unlicensed band has a threat of leading to a deterioration of communication quality.

That is, when LBT is made essential to all transmission operations, LBT has to be executed for control signals, synchronization signals or cell detection signals, which are important for communication. In this case, problems that might arise depending on the results of LBT include:

(1) control signals, random access preambles and scheduling request signals cannot be transmitted at predetermined timings, and their delays increase;

(2) synchronization cannot be maintained, and communication is disconnected with increased frequency; and

(3) adequate cells cannot be detected at appropriate timings, and the failure rates of connection, handover (HO) and so on increase. These problems grow as the period to limit (for example, stop) the transmission of signals based on LBT results lasts longer.

So, the present inventors have conceived of controlling the transmission of certain signals without employing LBT, in an LTE/LTE-A system (for example, LAA) that runs in an unlicensed band. That is, each transmission point (radio base station and/or user terminal) performs signal transmission that employs LBT (LBT-required transmission) and signal transmission that does not employ LBT (LBT-exempt transmission).

Employing LBT herein means performing listening (LBT) at predetermined timings (for example, before transmitting signals), and controlling transmission based on the results of listening (LBT results). Also, not employing LBT herein means not performing listening (skipping listening itself) at predetermined timings (for example, before transmitting signals), or performing listening at predetermined timings, but disregarding the results of listening (performing transmission regardless of the results of listening).

As signals that do not employ LBT (LBT-exempt transmission), signals that are used in cell detection/connection and so on in radio communication are selected. For example, selections can be made from the signals for cell detection, the synchronization signals, the signals for received quality measurements (RRM measurements (RSRP and RSSI measurements), CSI measurements, etc.), the control signals and so on.

To be more specific, a structure may be employed here in which, amongst the DL signals, at least one of the synchronization signals (PSS/SSS), the broadcast signal (PBCH signals), the cell-specific reference signal (CRS) and the channel measurement reference signal (CSI-RS) does not employ LBT. Also, as for the UL signals, a structure may be employed in which at least one of the random access signal (PRACH signal), the sounding reference signal (SRS) and the uplink control channel signal (PUCCH signal) does not employ LBT.

In this way, by eliminating cases where signals that are important in communication are not guaranteed transmission depending on the results of LBT, it is possible to guarantee securing connectability. Also, as for the data signals, interference control with nearby cell and other systems is made possible by employing LBT.

Also, with the present embodiment, each transmission point (radio base station and/or user terminal) configures the transmission cycles of the signals to which LBT is not applied (LBT-exempt signals) to be long cycles, and controls the transmissions of these LBT-exempt signals (LBT-exempt transmissions). As for the cycles to configure for the signals that do not require LBT, it is preferable to use cycles that are so long that the signals have only negligible impact on other systems (channel occupancy is little).

For example, each transmission point configures a predetermined cycle for part of the transmission signals (such that, for example, the maximum duty cycle is 5 percent in a 50-ms monitoring period), and performs signal transmissions that do not require LBT (LBT-exempt transmission). The predetermined cycle can be configured to fulfil conditions that are stipulated in advance in the specification.

In this way, according to the present embodiment, a radio base station (eNB) has a capability for transmitting both signals that do not employ LBT (LBT-exempt signals) and signals that employ LBT (LBT-required signals) on the downlink (DL), and operates differently depending on which signals are transmitted. Also, the radio base station (eNB) has a capability for receiving both LBT-exempt signals and LBT-required signals on the uplink (UL), and operates differently depending on which signals are received.

Furthermore, a user terminal (UE) has a capability for receiving both LBT-exempt signals and LBT-required signals in DL, and operates differently depending on which signals are received. Also, the user terminal (UE) has a capability for transmitting both LBT-exempt signals and LBT-required signals in UL, and operates differently depending on which signals are transmitted.

Now, the present embodiment will be described below in detail with reference to the accompanying drawings.

### First Example

With a first exempt signal transmissions on the downlink (DL) that do not employ LBT (LBT-exempt transmissions) will be described.

As mentioned earlier, a radio base station transmits both signals to which LBT is not applied (LBT-exempt signals) and signals to which LBT is applied (LBT-required signals) on the downlink. For example, the radio base station transmits the signals which user terminals use for cell detection/measurements, connection and so on, without applying LBT.

To be more specific, the radio base station controls the transmission of at least one of the synchronization signals (PSS/SSS), the broadcast signal (PBCH signal), the cell-specific reference signal (CRS) and the channel measurement reference signal (CSI-RS), without applying LBT. Meanwhile, the radio base station controls the transmissions of the downlink shared channel signal (PDSCH signal), the downlink control channel signal (PDCCH signal/EPDCCH signal), the PCFICH (Physical Control Format Indicator CHannel) signal and the PHICH (Physical Hybrid-ARQ Indicator CHannel) signal by applying LBT.

In this way, by not applying LBT to signals that are important in communication, it is possible to prevent the deterioration of signal quality that arises due to signal delays, signal disconnections, cell detection failures and so on in LTE-U. Also, LBT is applied to data signals and other signals, so that interference control with nearby cells and other systems is made possible.

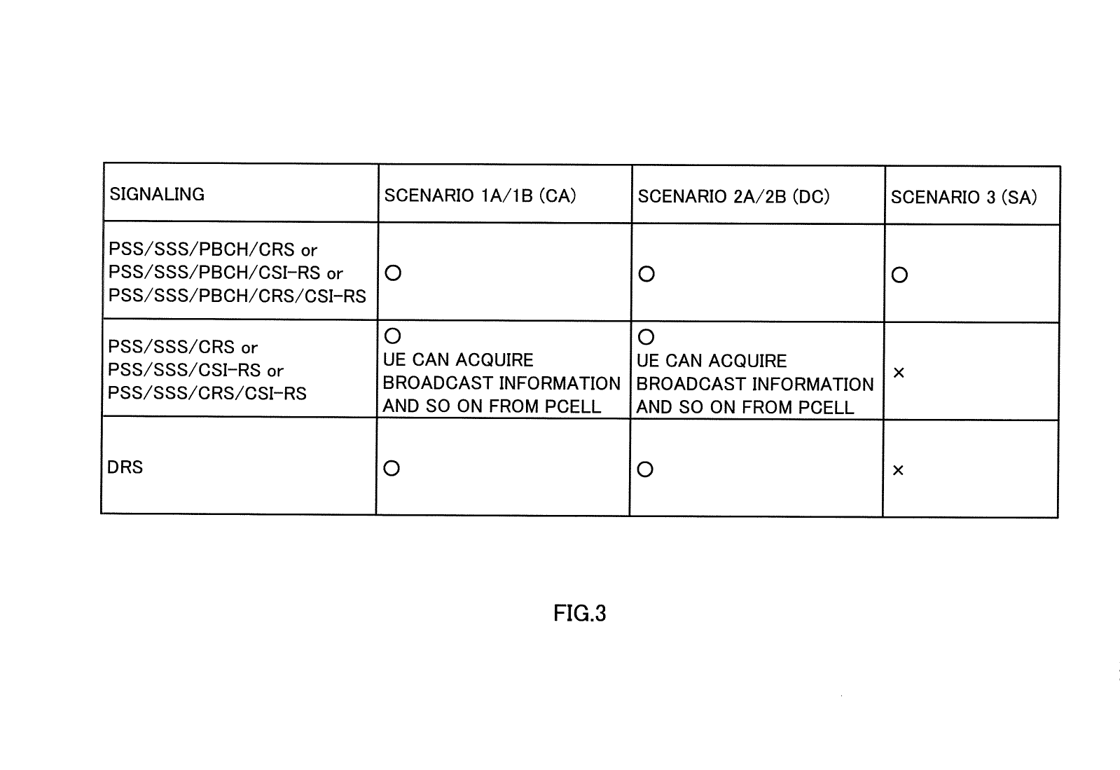

Furthermore, among a plurality of DL signals that are transmitted from the radio base station, the combination of DL signals to make LBT-exempt signals can be determined considering unlicensed band scenarios. For example, it is possible to select the DL signals that serve as LBT-exempt signals, separately, for scenarios 1A/1B (employing CA), scenarios 2A/2B (employing DC) and scenario 3 (employing SA) of FIG. 1 (see FIG. 3).

In particular, when the radio base station and a user terminal connect by using a licensed band and an unlicensed band (CA/DC), the user terminal can receive DL signals via the licensed band, where LBT is not used. So, in scenario 1 or 2, it is possible to make the PBCH an LBT-required signal, and allow the user terminal to receive information that is transmitted in the PBCH from licensed band cells.

Furthermore, it is also possible to make the signal (DRS) that is used in the on/off control of small cells an LBT-exempt signal. The DRS can be made a signal to be transmitted in the DwPTS field in DL subframes or TDD special subframes. Note that the DL signals that serve as LBT-exempt signals with the present embodiment are by no means limited to the above-noted signals.

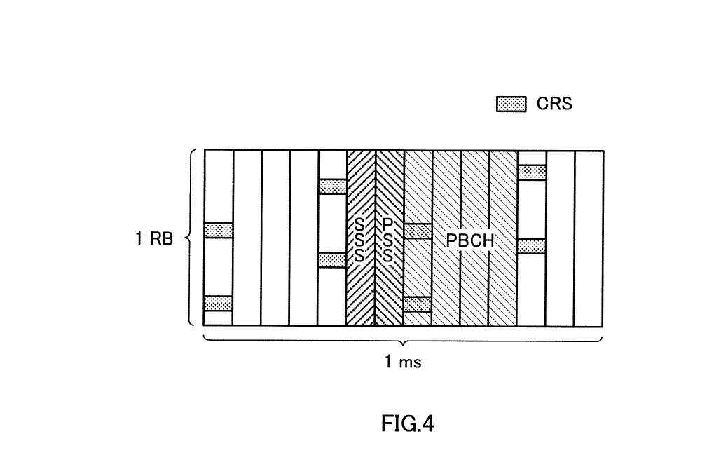

Now, in existing LTE/LTE-A systems, the synchronization signals (PSS/SSS), the broadcast signal (PBCH signal), the cell-specific reference signal (CRS) and the channel measurement reference signal (CSI-RS) are all allocated to predetermined symbols in a predetermined cycle. The details of allocation are as follows (see FIG. 4). Note that FIG. 4 shows an example of allocation of the CRS, the PSS/SSS and the PBCH in one transmission time duration (one subframe).

PSS: 2 symbols/10 ms

SSS: 2 symbols/10 ms

PBCH: 16 symbols/40 ms

CRS: 4 symbols/1 ms (for one antenna port measurement)

CSI-RS: 2 symbols/5 ms

A case will be assumed here in which the radio base station transmits the PSS, the SSS, the PBCH and the CRS as LBT-exempt signals. In this case, in a range of 10 ms (14×10 symbols), the number of symbols to which LBT-exempt signals are allocated is 47 symbols. Note that, here, when a plurality of signals (for example, the PBCH signal and the CRS) are allocated to the same symbol in an overlapping manner, this is counted as one symbol.

Also, a case will be assumed in which the radio base station transmits the PSS, the SSS and the CRS as LBT-exempt signals. In this case, in a range of 10 ms, the number of symbols to which LBT-exempt signals are allocated is 44 symbols.

In this way, when conventional DL signals are transmitted as LBT-exempt signals, depending on the types of DL signals to be configured as LBT-exempt signals, the proportion of LBT-exempt signals (the number of symbols) to be allocated in a predetermined period (for example, 50 ms) increases. Also, if LBT-exempt signals are transmitted with high frequency in an unlicensed band, there is a threat that the impact on other systems and so on increases.

Consequently, with the present embodiment, it is possible to control the transmissions of LBT-exempt signals (for example, the PSS, the SSS, the PBCH, the CRS and/or the CSI-RS) by applying longer configurations (for example, longer cycles) than in allocation methods in existing systems. Alternatively, in addition to controlling the allocation cycle of LBT-exempt signals, it is also possible to configure the allocation density of LBT-exempt signals low and control their transmissions.

For example, the radio base station controls the allocation of LBT-exempt signals to fulfill predetermined conditions (for example, the duty cycle is 5 percent or less in a 50-ms range). To make the duty cycle 5 percent or less in a 50-ms range, the transmissions of LBT-exempt signals are controlled so that the LBT-exempt signals are allocated to 35 or fewer symbols within a range of 50 ms (7 symbols per 10-ms range). Obviously, the conditions for the transmission cycle of LBT-exempt signals and so on are by no means limited to this. When there are predetermined conditions upon execution of LBT, the radio base station has only to control the transmissions of LBT-exempt signals to fulfill these conditions.

Now, the allocation method (the transmission cycle, the transmission density and so on) of LBT-exempt signals in unlicensed bands will be described below. Note that, although a case will be illustrated in the following description where the conventional PSS, SSS, PBCH and CRS are transmitted (allocated) as LBT-exempt signals by changing their transmission cycles, transmission densities and so on, the transmission cycle and allocation density of each signal are by no means limited to these. Also, the allocation method of each signal can be combined and applied as appropriate.

(Change of Transmission Cycle)

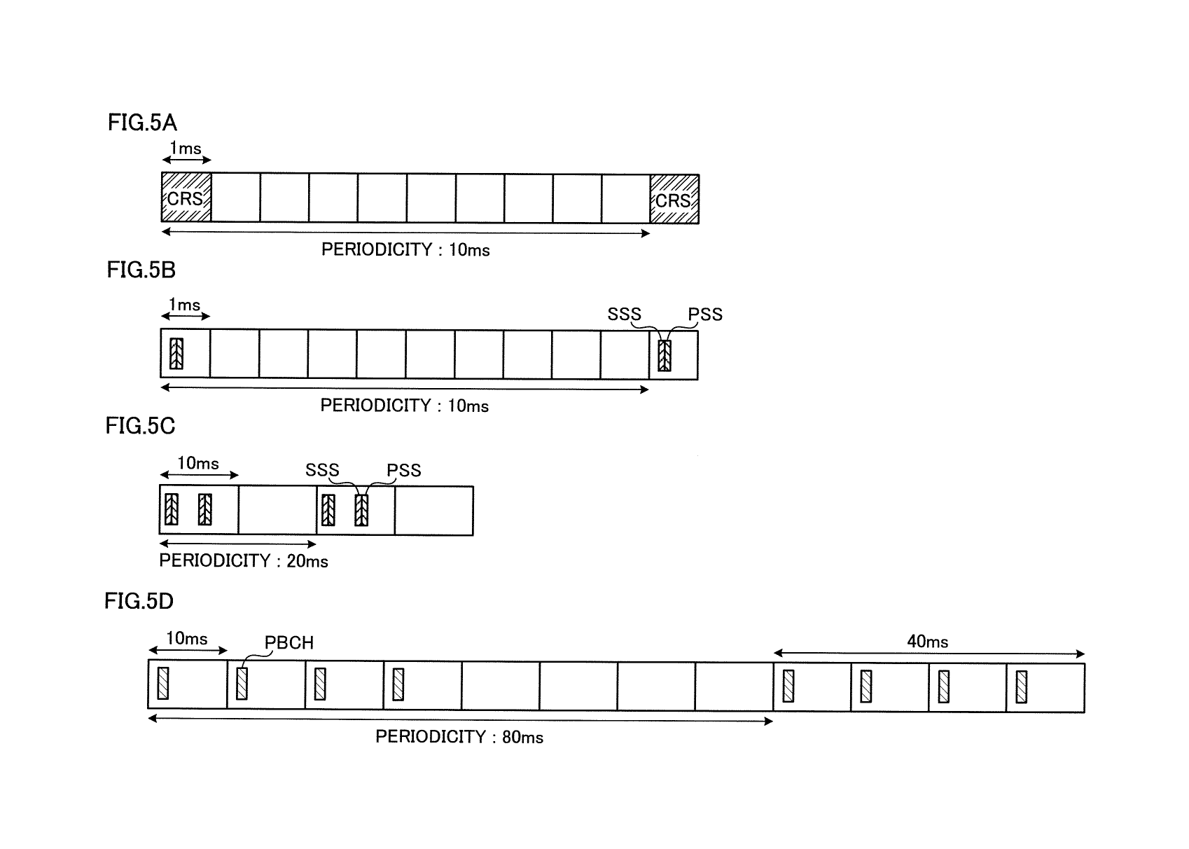

FIG. 5 show cases in which, in an unlicensed band, the transmission cycles of DL signals, to which LBT is not applied, are configured longer than transmission cycles in existing systems. Note that, in licensed bands where LBT is not employed, transmission cycles for existing systems can be used.

FIG. 5A shows an example of a CRS allocation method (transmission method). As shown in FIG. 5A, in an unlicensed band, a radio base station configures the transmission cycle of the CRS, which serves as an LBT-exempt signal, longer than the existing CRS transmission cycle (1 ms). Here, a case is shown, as one example, where the CRS, to which LBT is not applied, is configured and transmitted in a 10-ms transmission cycle. By this means, it is possible to reduce the proportion (overhead) of the transmission of the CRS that serves as an LBT-exempt signal, and reduce the interference against other cells, and, furthermore, keep transmitting the CRS regardless of the results of LBT.

FIG. 5B and FIG. 5C show examples of synchronization signal (PSS/SSS) allocation methods. Existing synchronization signals (PSS/SSS) are allocated to subframe #0 and subframe #5 in one frame (10 subframes). FIG. 5B shows a case where the radio base station configures the transmission cycle of synchronization signals (PSS/SSS), to which LBT is not applied, longer than the existing synchronization signal transmission cycle (5 ms). FIG. 5B shows a case in which the transmission cycle of the synchronization signals is configured to be 10 ms.

FIG. 5C shows a case in which the radio base station configures the transmission cycle of synchronization signals, to which LBT is not applied, every 2 frames. That is, the synchronization signal transmission cycle (5 ms) in one frame is maintained, and the frame duration to allocate the synchronization signals is configured long. In this case, the cycle of the PSS/SSS does not change within a frame, in radio frames where the PSS/SSS are present, so that it is possible to maintain the cell detection performance of user terminals that are capable of cell detection in a single frame. Meanwhile, the radio frames to transmit the PSS/SSS are limited, which results in an apparent decrease in the transmission of the PSS/SSS, and makes it unnecessary to apply LBT.

In this way, by making the transmission cycle of synchronization signals that serve as LBT-exempt signals longer than the cycle in existing systems (or in licensed bands), it is possible to reduce the proportion (overhead) of the transmission of synchronization signals in unlicensed bands, and reduce the interference against other cells. Furthermore, it is possible to keep transmitting synchronization signals regardless of the results of LBT.

FIG. 5D shows an example of a PBCH allocation method (transmission method). As shown in FIG. 5D, in an unlicensed band, the radio base station configures the transmission cycle of the PBCH, to which LBT is not applied, longer than the existing PBCH transmission cycle. Here, a case is illustrated as an example in which the transmission of the PBCH, which serves as an LBT-exempt signal, is controlled by configuring a transmission cycle of 80 ms (allocated every 10 ms, over 40 ms). By this means, it is possible to reduce the proportion (overhead) of the transmission of the PBCH that serves as an LBT-exempt signal, and reduce the interference against other cells, and, furthermore, keep transmitting the PBCH regardless of the results of LBT.

In this way, the radio base station can extend the transmission cycles of reference signals, broadcast information, control signals and so on that are required in cell detection/measurement, synchronization and other processes, and repeat transmissions as LBT-exempt transmissions. Also, while the radio base station transmits LBT-exempt signals regardless of the results of LBT, the radio base station controls the transmissions of LBT-required signals based on LBT results (for example, determines whether or not transmission is possible). When determining whether or not an LBT-required signal can be transmitted based on the result of LBT, the radio base station can make the decision by comparing the interference power value that is detected/measured, with a predetermined threshold.

Also, the radio base station can report information about the LBT-exempt signal (for example, the transmission cycle and so on) to a user terminal in advance. Alternatively, the information about the LBT-exempt signal (for example, the transmission cycle and so on) may be stipulated in advance in the specification. The user terminal can adequately detect the LBT-exempt signal (which may be a reference signal, broadcast information and so on) in a predetermined cycle, based on the information about the LBT-exempt signal that is reported from the radio base station or stipulated in the specification.

Also, since the LBT-exempt signal is transmitted regardless of the results of LBT, the user terminal can perform the receiving operations (for example, cell detection and so on) on the assumption that this signal is transmitted in an LBT-exempt signal cycle that is acquired in advance.

Also, based on the detection result of the LBT-exempt signal, the user terminal controls the connection to the cell transmitting this signal. For example, the user terminal feeds back the signal's detection and/or measurement results and so on to the network (for example, a licensed band cell), and establishes connection with the detected cell following commands from the network. The commands from the network include a handover (HO) command, an SCell configuration (for example, “SCell configure”) that is given through dedicated signaling, and so on.

Also, the user terminal may be structured to report whether or not it has an LBT-exempt signal detection capability, to the network (radio base station) in advance. The network (radio base station) identifies user terminals that have an LBT-exempt signal detection capability, and commands the cell detection operations to use LBT-exempt signals in unlicensed bands, to the user terminals. By this means, it is possible to prevent terminals that are unable to execute the cell detection operations using LBT-exempt signals from trying conventional cell detection in such cells, so that the power consumption of the user terminals can be saved.

The above-noted detection capabilities may be stipulated per frequency or band. When detection capabilities are stipulated per frequency or band, the user terminal reports the indicators of frequencies and bands, in which the user terminal can detect LBT-exempt signals, to the network. The requirements for interference control in unlicensed bands vary per country, region or frequency. Consequently, by stipulating detection capabilities on a per frequency or band basis, the user terminal does not have to have LBT-exempt signal detection capabilities for all the possible frequencies and bands, and only needs to have detection capabilities that match the country, region or frequency in which the user terminal is primarily used, so that it is possible to save the cost of implementing the terminal.

The above-noted detection capabilities may be stipulated on a per user terminal basis. The user terminal reports to the network that the user terminal has a capability for detecting LBT-exempt signals, regardless of the frequency and the band. By this means, the network can command cell detection that is based on LBT-exempt signals, to all user terminals having the above capability, so that user terminals can be accommodated in unlicensed bands effectively.

The above detection capabilities may serve as indicators to show capabilities to enable cell detection that is based on LBT-exempt signals, not only in unlicensed bands, but also in licensed bands. When detection capabilities are stipulated per frequency or band, a report is sent to the network in advance if a detection capability in a specific licensed band is found. When detection capabilities are stipulated on a per user terminal basis, a user terminal reports that it can execute cell detection that is based on LBT-exempt signals in an arbitrary frequency or band, to the network, in advance. In licensed bands, inter-cell interference becomes the problem in areas where cells are deployed densely. Consequently, by employing an LBT-exempt signal-based cell detection function for unlicensed bands in licensed bands, it is possible to make the signal transmission cycle longer in these areas, and thereby reduce the inter-cell interference.

(Change of Allocation Density)

When a signal that is determined to be transmitted repetitively (for example, broadcast information (PBCH signal)) is made an LBT-exempt signal, the radio base station can lower the signal density by reducing the number of repetitions. In this case, the radio base station may configure an extended transmission cycle for the LBT-exempt signal, and, furthermore, control the transmission by reducing the number of repetitions.

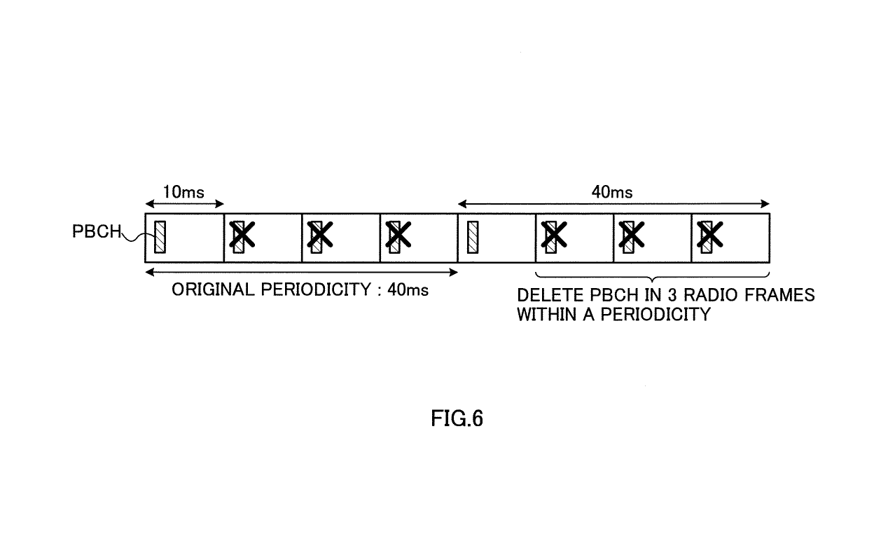

FIG. 6 shows an example of a PBCH allocation method. As shown in FIG. 6, the radio base station applies configurations so that the PBCH, to which LBT is not applied, is allocated less frequently than the existing PBCH in an unlicensed band. Here, a case is illustrated as an example in which the existing PBCH, which is allocated every 10 ms (one frame) over 40 ms (4 frames), is not allocated for 30 ms (3 frames). That is, the signal density is lowered by reducing the number of times to repeat allocating the PBCH signal that serves as an LBT-exempt signal from 4 to 1.

By this means, it is possible to reduce the proportion (overhead) of the transmission of the PBCH that serves as an LBT-exempt signal, and reduce the interference against other cells, and, furthermore, keep transmitting the PBCH regardless of the results of LBT.

Also, the radio base station can report, in advance, information about the number of times to repeat the PBCH signal, to which LBT is not applied, to user terminals, in an unlicensed band. Alternatively, the information about the number of repetitions of the PBCH signal may be stipulated in advance in the specification. The user terminal can adequately detect the PBCH signal, to which LBT is not applied, based on the information about the number of repetitions reported from the radio base station or stipulated in the specification.

Also, since LBT-exempt signals are transmitted regardless of the results of LBT, the user terminal can perform the receiving operations (for example, the decoding process and so on) on the assumption that this signal is transmitted with a number of repetitions for LBT-exempt signals that is acquired in advance.

Note that, although the PBCH signal has been described as an example here, the signals to which the present embodiment is applicable are by no means limited to this. The radio base station can control the transmissions of LBT-exempt signals by adequately reducing their allocation densities.

(Method of Allocating Multiple LBT-Exempt Signals)

When multiple types of DL signals (for example, the PSS/SSS, the PBCH, the CRS and so on) are made LBT-exempt signals, a structure may be employed in which these multiple types of LBT-exempt signals are allocated to predetermined subframes. In this case, the radio base station takes into account the transmission cycles of the multiple DL signals that serve as LBT-exempt signals, and determines predetermined subframes for gathering and allocating these multiple DL signals. Then, the radio base station can transmit a plurality of DL signals as LBT-exempt signals in these predetermined subframes.

For example, assume a case where the PSS/SSS, the PBCH and the CRS are transmitted as LBT-exempt signals. Subframes #0, #10, #20, #30, #40 and so on are the subframes in which the transmission cycles of these signals overlap (common multiples of each signal's transmission cycle). The radio base station can be structured to transmit LBT-exempt signals using part or all of subframes #0, #10, #20, #30, #40 and so on.

Alternatively, the radio base station may determine specific subframes for transmitting LBT-exempt signals, and transmit multiple types of DL signals as LBT-exempt signals in these specific subframes. Note that the specific subframes do not have to be determined by the radio base station, and can be subframes that are stipulated in advance in the specification and so on.

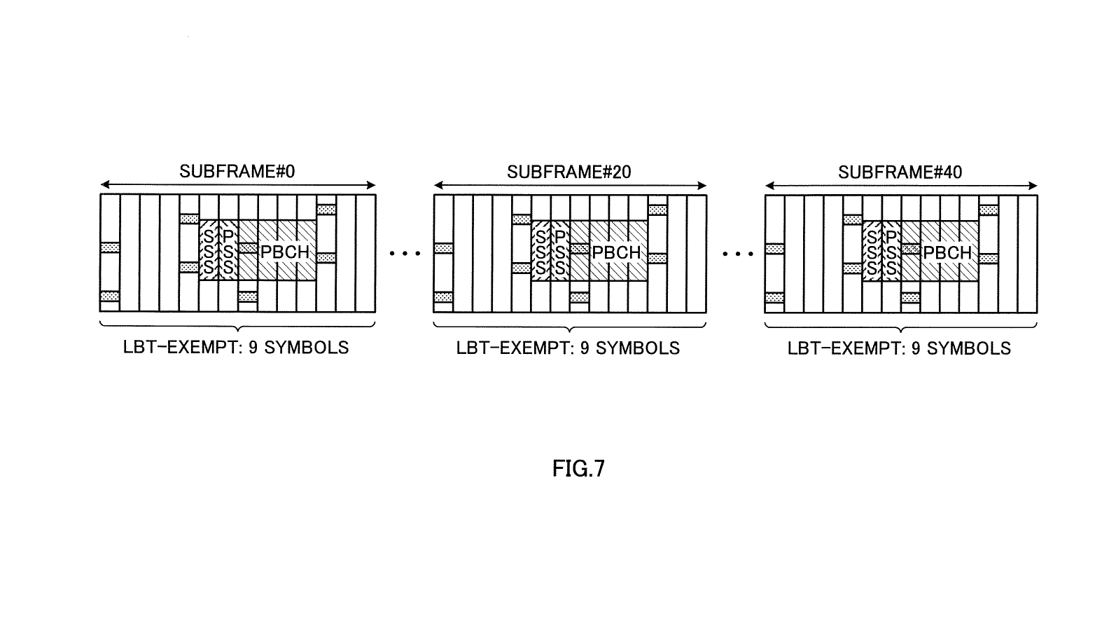

FIG. 7 shows a case in which the radio base station transmits the PSS/SSS, the PBCH and the CRS as LBT-exempt signals in subframes #0, #20, #40 and so on that show up in a predetermined transmission cycle (here, 20 ms). In this case, the overhead of LBT-exempt signals is 27 symbols ((9 symbols/subframe)×3) in 50 ms.

Note that the radio base station may not transmit the PSS/SSS, the PBCH and the CRS in subframes other than the subframes that are configured in a predetermined transmission cycle (for example, subframes #0, #20, #40 and so on), or may transmit the PSS/SSS, the PBCH and the CRS by applying LBT, as with other signals.

In FIG. 7, in subframes where LBT-exempt signals are allocated (for example, subframes #0, #20, #40 and so on), the allocation of LBT-required signals other than the PSS/SSS, the PBCH and the CRS that serve as LBT-exempt signals can be controlled based on LBT results. For example, when a signal from outside is detected upon pre-transmission LBT in subframes #0, #20 and #40, the radio base station transmits LBT-exempt signals, but does not transmit LBT-required signals. On the other hand, when no signal from outside is detected upon pre-transmission LBT, the radio base station can transmit both LBT-required signals and LBT-exempt signals.

Alternatively, the radio base station may be structured not to allocate LBT-required signals in subframes where a plurality of LBT-exempt signals are allocated (for example, subframes #0, #20, #40 and so on), regardless of the results of LBT.

In this way, by allowing the radio base station to gather and transmit a plurality of channels and signals, to which LBT is not applied, in one subframe, it is possible to reduce the overhead of LBT-exempt signals and reduce the interference against other cells, and, furthermore, keep transmitting LBT-exempt signals regardless of the results of LBT.

Note that, although FIG. 7 shows a case where a plurality of LBT-exempt signals are transmitted in predetermined subframes, it is equally possible to employ a structure in which LBT is applied to none of these signals in these predetermined subframes. That is, the radio base station can be controlled to either perform LBT-required transmissions or perform LBT-exempt transmissions, in subframe units. Note that subframes to which LBT is not applied may be referred to as “LBT-exempt subframes.”

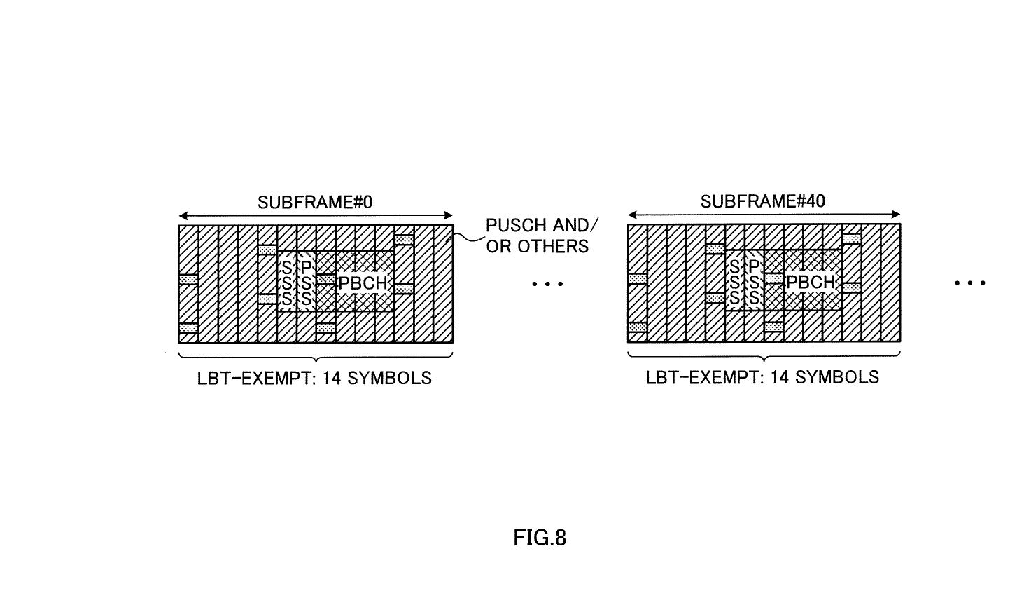

The radio base station can transmit signals (control signals, data signals, reference signals and so on) that are allocated to all symbols (for example, 14 symbols) in LBT-exempt subframes, as LBT-exempt signals (see FIG. 8). That is, in LBT-exempt subframes, the radio base station also transmits the PDCCH, the PHICH, the PDSCH and so on without applying LBT (regardless of the results of LBT). Here, the number of LBT-exempt subframes can be configured to be M subframes per N subframes.

FIG. 8 shows a case where LBT-exempt subframes are configured in a 40-ms cycle (M=1 and N=40). In this case, the overhead of LBT-exempt signals is 28 symbols ((14 symbols/subframe)×2) in 50 ms.

Note that the radio base station can report information about the predetermined subframes for transmitting a plurality of LBT-exempt signals in FIG. 7 and FIG. 8 (for example, the transmission cycles, lengths, offsets and so on) to the user terminal. The information about predetermined subframes may be stipulated in advance in the specification. The user terminal can adequately perform the LBT-exempt signal receiving operations (for example, cell detection/measurements) based on the information about predetermined subframes reported from the radio base station or stipulated in the specification.

Also, since LBT-exempt signals are transmitted from the radio base station regardless of the results of LBT, the user terminal can perform the receiving operations (for example, cell detection and so on) by presuming LBT-exempt signal transmissions based on information about predetermined subframes that is acquired in advance.

(Variation)

For signals that serve as LBT-exempt signals (for example, the PSS/SSS, the PBCH, the CRS, the CSI-RS and so on), two formats—namely, an LBT-required signal format and an LBT-exempt signal format—may be configured for the same signal. For example, in an unlicensed band serving cell, LBT-required signals are configured to be transmitted in a short cycle (for example, in an existing transmission cycle), and LBT-exempt signals are configured to be transmitted in a long cycle so that LBT is not essential.

In this case, LBT-required signals and LBT-exempt signals can be reported to user terminals in distinguishable forms (for example, through separate signaling).

Given the same signal (for example, the CRS), the radio base station determines whether or not the signal can be transmitted based on the result of LBT if the signal is an LBT-required signal, and controls the transmission of the signal regardless of the result of LBT if the signal is an LBT-exempt signal. Given the same signal, when LBT is not applied to the signal, the user terminal performs the receiving operations (for exempt signal detection) on the assumption that the signal is transmitted regardless of the result of LBT. On the other hand, when LBT is applied, whether or not the signal is transmitted/received is determined based on the result of LBT, so that the user terminal can perform the receiving operations on the assumption that quality may not be necessarily guaranteed. By this means, it is possible to prevent the cell detection failure rate in the user terminal from increasing.

By this means, when there is no interference in the surroundings, LBT-required signals and LBT-exempt signals are both transmitted, so that it is possible to increase the number of users to connect with unlicensed band cells, achieve improved quality, and so on. Also, when there is interference in the surroundings, LBT-required signals are not transmitted, but LBT-exempt signals are transmitted, so that it is possible to transmit the signals that are necessary for cell detection and so on reliably, and, meanwhile, reduce the interference against other cells.

### Second Example

The transmissions of LBT-exempt signals (LBT-exempt transmissions) on the uplink (UL) will be described with a second example.

A user terminal transmits both LBT-exempt signals and LBT-required signals on the uplink (UL). For example, the user terminal controls the transmission of at least one of the sounding reference signal (SRS), the random access signal (PRACH signal) and uplink control information to feed back channel state information (PUCCH signal), without applying LBT. Meanwhile, LBT can be applied to the uplink shared channel signal (PUSCH signal) and so on.

In this way, by not applying LBT to signals that are important in communication, it is possible to prevent the deterioration of signal quality that arises due to signal delays, signal disconnections, cell detection failures and so on in LTE-U. Also, LBT is applied to data signals and other signals, so that interference control with nearby cells and other systems is made possible.

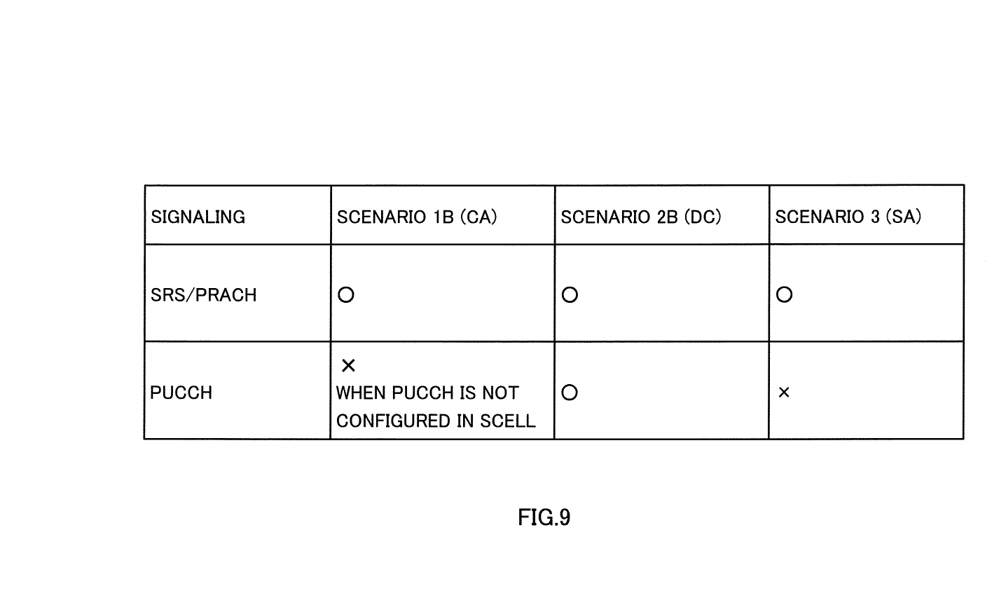

Furthermore, among a plurality of UL signals that are transmitted from the user terminal, the combination of UL signals to make LBT-exempt signals can be determined considering unlicensed band scenarios. For example, it is possible to select the UL signals that serve as LBT-exempt signals, separately, for scenarios 1A/1B (employing CA), scenarios 2A/2B (employing DC) and scenario 3 (employing SA) of FIG. 1 (see FIG. 9).

In particular, when a radio base station and a user terminal execute CA by using a licensed band and an unlicensed band, a mode in which the user terminal transmits uplink control signals (PUCCH signals) by using the licensed band that serves as the primary cell, without using the unlicensed band that serves as a secondary cell, may be possible. Consequently, in this transmission mode (scenario 1B), the user terminal preferably makes the PUCCH an LBT-required signal, and transmits the SRS and the PRACH as LBT-exempt signals.

Now, in existing LTE/LTE-A systems, the SRS and the PRACH signals are allocated based on predetermined rules. For example, with the SRS, one symbol is allocated every 2 ms, 5 ms, 10 ms, 20 ms and so on. Also, with the PRACH, 14 symbols are allocated every 1 ms as a minimum transmission cycle (minimum periodicity).

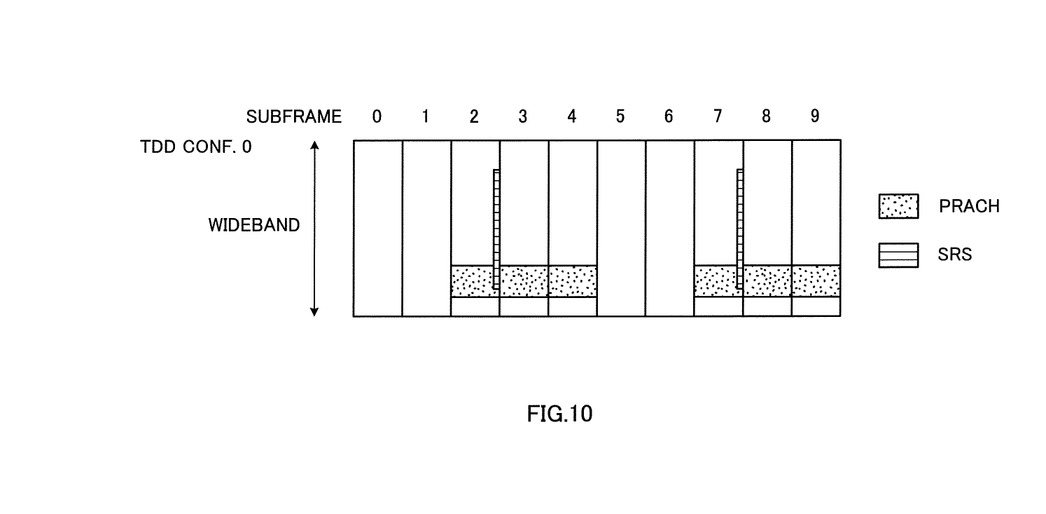

FIG. 10 shows an example of the SRS and PRACH allocation method for use when UL/DL configuration 0 (UL/DL Conf. 0) in TDD is employed. FIG. 10 shows a case in which the user terminal allocates the periodic SRS to subframes #2 and #7 in one frame (10 subframes), and allocates the PRACH to subframes #2 to #4 and #7 to #9. Obviously, the present embodiment is not limited to TDD, and FDD is equally applicable.

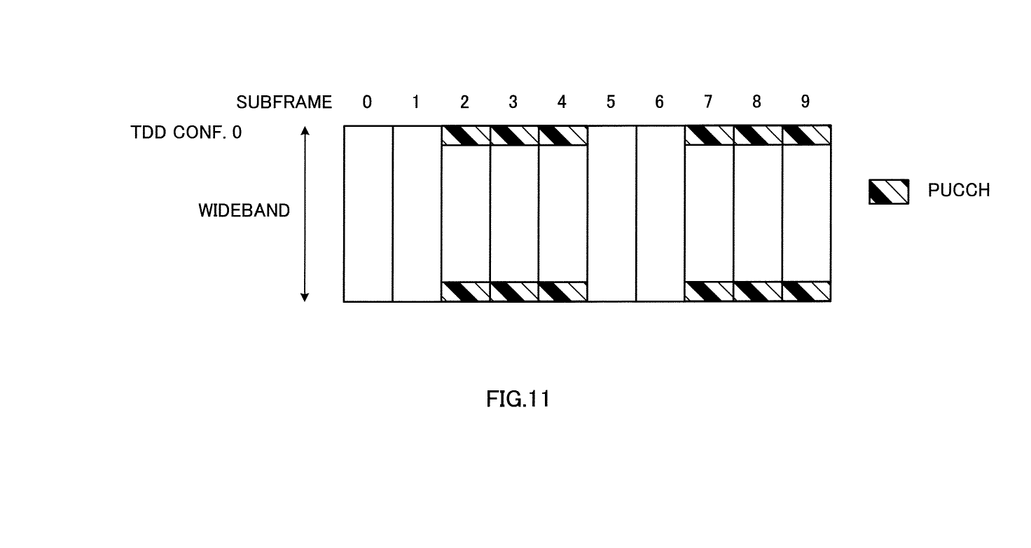

FIG. 11 shows an example of the PUCCH allocation method for use when UL/DL configuration 0 (UL/DL Conf. 0) in TDD is employed. FIG. 11 shows a case where, in one frame (10 subframes), the user terminal allocates the PUCCH to subframes #2 to #4 and #7 to #9. Periodic CSI is included in part or all of the PUCCHs allocated to each subframe.

In this way, when conventional UL signals are transmitted as LBT-exempt signals, depending on the types of UL signals configured as LBT-exempt signals, the proportion (number of symbol) of LBT-exempt signals to be allocated in a predetermined cycle (for example, 50 ms) increases. Also, when LBT-exempt signals are transmitted with high frequency in an unlicensed band, there is a threat that the impact upon other systems and so on grows.

Consequently, with the present embodiment, it is possible to control the transmissions of LBT-exempt signals (including, for example, the SRS, the PRACH and/or the PUCCH) by applying different allocation methods from those of existing systems (for example, by configuring longer transmission cycles). Alternatively, in addition to controlling the allocation cycles of LBT-exempt signals, it is also possible to configure the allocation densities of LBT-exempt signals lower and control their transmissions. Also, it is equally possible to transmit LBT-exempt signal with low transmission power compared to LBT-required signals.

For example, the user terminal and/or the radio base station control the allocation of UL signals that serve as LBT-exempt signals to fulfill predetermined conditions (for example, the duty cycle is 5 percent or less in a 50-ms range). To make the duty cycle 5 percent or less in a 50-ms range, the transmissions of LBT-exempt signals are controlled so that the LBT-exempt signals are allocated to 35 or fewer symbols within a range of 50 ms (7 symbols per 10-ms range). Obviously, the conditions for the transmission cycle of LBT-exempt signals and so on are by no means limited to this. When there are predetermined conditions upon execution of LBT, the radio base station has only to control the transmissions of LBT-exempt signals to fulfill these conditions.

Now, the allocation method (the transmission cycle and so on) of LBT-exempt signals in unlicensed bands will be described below. Note that, although a case will be illustrated in the following description where the conventional SRS and PRACH are transmitted (allocated) as LBT-exempt signals by changing their transmission cycles and so on, this by no means limits the transmission cycle and so on of each signal. Also, the UL signals to make LBT-exempt signals are not limited to the SRS and PRACH signals.

When multiple types of UL signals (for example, the SRS and the PRACH) are made LBT-exempt signals, the user terminal may be structured to allocate these multiple types of LBT-exempt signals to predetermined subframes. In this case, the user terminal and/or the radio base station take into account the transmission cycles of the multiple UL signals that serve as LBT-exempt signals, and determine predetermined subframes for gathering and allocating these multiple UL signals. Then, the user terminal can transmit a plurality of UL signals as LBT-exempt signals in these predetermined subframes.

Alternatively, the user terminal and/or the radio base station may determine specific subframes for transmitting LBT-exempt signals, and transmit multiple types of UL signals as LBT-exempt signals in these specific subframes. Note that the specific subframes do not have to be determined by the radio base station, and can be subframes that are stipulated in advance in the specification and so on.

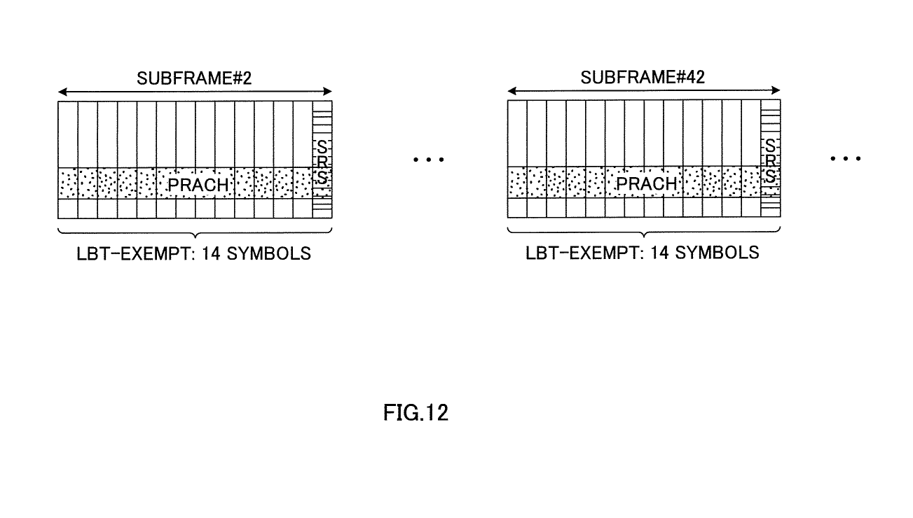

For example, assume a case where the SRS and the PRACH are transmitted as LBT-exempt signals. In this case, as shown in FIG. 12, the user terminal transmits the SRS and PRACH signals as LBT-exempt signals in predetermined subframes (here, subframes #2 and #42). In FIG. 12, the overhead of LBT-exempt signals is 28 symbols ((14 symbols/subframe)×2) in 50 ms.

Note that the user terminal may not transmit the SRS and/or the PRACH in subframes other than the subframes that are configured in a predetermined transmission cycle (for example, subframes #2, #42 and so on), or may transmit the SRS and/or the PRACH by applying LBT, as with other signals (for example, the PUSCH signal).

In FIG. 12, in subframes where LBT-exempt signals are allocated (for example, subframes #2, #42 and so on), the allocation of LBT-required signals other than the SRS and the PRACH that serve as LBT-exempt signals can be controlled based on LBT results. For example, when a signal from outside is detected upon pre-transmission LBT in subframes #2 and #42, the user terminal transmits LBT-exempt signals, but does not transmit LBT-required signals. On the other hand, when no signal from outside is detected upon pre-transmission LBT, the user terminal transmits both LBT-required signals and LBT-exempt signals.

Alternatively, a structure may be employed here in which LBT-required signals are not allocated to subframes where a plurality of LBT-exempt signals are allocated (for example, subframes #2, #42 and so on), regardless of the results of LBT.

In this way, by allowing the user terminal to gather and transmit a plurality of channels and signals, to which LBT is not applied, in one subframe, it is possible to reduce the overhead of LBT-exempt signals and reduce the interference against other cells, and, furthermore, keep transmitting LBT-exempt signals regardless of the results of LBT.

Note that, although FIG. 12 shows a case where a plurality of LBT-exempt signals are transmitted in predetermined subframes, it is equally possible to employ a structure in which LBT is applied to none of these signals in these predetermined subframes. That is, the user terminal (or the radio base station) can be controlled to either perform LBT-required transmissions or perform LBT-exempt transmissions, in subframe units. Note that subframes to which LBT is not applied may be referred to as “LBT-exempt subframes.”

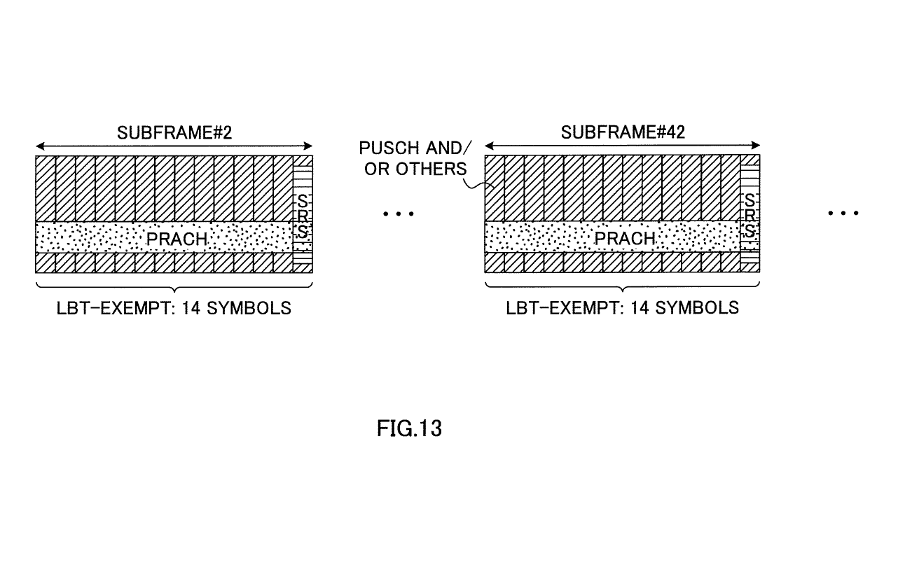

The user terminal can transmit signals (control signals, data signals, reference signals and so on) that are allocated to all symbols (for example, 14 symbols) in LBT-exempt subframes, as LBT-exempt signals (see FIG. 13). That is, in LBT-exempt subframes, the user terminal also transmits the PUSCH, the PUCCH, the DM-RS and so on without applying LBT (regardless of the results of LBT). Here, the number of LBT-exempt subframes can be configured to be P subframes per Q subframes.

FIG. 13 shows a case where LBT-exempt subframes are configured in a 40-ms cycle (P=1 and Q=40). In this case, the overhead of LBT-exempt signals is 28 symbols ((14 symbols/subframe)×2) in 50 ms.

Note that the radio base station can report information about the predetermined subframes for transmitting a plurality of LBT-exempt signals in FIG. 12 and FIG. 13 (for example, the transmission cycles, lengths, offsets and so on) to the user terminal. The information about predetermined subframes may be stipulated in advance in the specification. The user terminal can adequately perform the LBT-exempt signal receiving operations (for example, cell detection/measurements) based on the information about predetermined subframes reported from the radio base station or stipulated in the specification.

(Variation)

When LBT is applied to UL transmission, the following two ways are possible:

(1) the method in which the user terminal performs LBT and controls UL transmission based on the results of LBT; and

(2) the method in which the radio base station performs LBT and commands UL transmission (UL grant) to the user terminal based on the results of LBT. Consequently, the user terminal may use LBT-required transmission and LBT-exempt transmission, depending on UL signals (the SRS, the PRACH signal, the PUCCH signal and so on), as appropriate, as described below.

<PRACH>

For the PRACH signal, the user terminal can decide whether or not LBT can be applied depending on the types of PRACH signals (the contention-based RACH and the non-contention-based RACH). For example, for the contention-based RACH, the transmission of which is autonomously controlled by the user terminal, the user terminal autonomously makes decisions regarding its transmission. Consequently, the user terminal applies LBT to the contention-based RACH on the user terminal side, and controls its transmission.

Meanwhile, for the non-contention-based RACH that is transmitted based on commands from the radio base station, the radio transmission decides whether or not transmission is possible. Consequently, the user terminal does not perform LBT for the non-contention-based RACH on the user terminal side, and can control its transmission as an LBT-exempt signal.

<SRS>

For the SRS, the user terminal can determine whether or not LBT can be applied depending on what type this SRS is (periodic or aperiodic). For example, the SRS that is transmitted periodically (periodic SRS) is transmitted in a cycle that is configured by higher layers. Consequently, the user terminal side applies LBT to the periodic SRS and controls its transmission.

On the other hand, the SRS that is transmitted aperiodically (based on triggers) (aperiodic SRS) is triggered dynamically by downlink control signals (DL assignment/UL grant) from the radio base station. Consequently, the user terminal can control the transmission of the aperiodic SRS as an LBT-exempt signal on the user terminal side, without applying LBT.

<PUCCH>

For the PUCCH, the user terminal can determine whether or not LBT can be applied depending on the types of signals to transmit in this PUCCH. For example, the user terminal transmits periodically-transmitted CSI (periodic CSI) and scheduling requests (SRs) in cycles that are configured from a higher layer. Consequently, the user terminal controls the transmissions of periodic CSI and SRs by applying LBT on the user terminal side.

On the other hand, CSI that is transmitted aperiodically (based on triggers) (aperiodic CSI) and HARQ-ACK are dynamically triggered by downlink control signals (DL assignment/UL grant) from the radio base station. Consequently, the user terminal can control the transmissions of aperiodic CSI and HARQ-ACK as LBT-exempt signals, without applying LBT on the user terminal side.

In this way, by determining whether or not to apply LBT (whether or not to make LBT-exempt signals) depending on the types of signals, it is possible to configure LBT-exempt signals adequately.

Note that, with the present embodiment, cases might occur where an LBT-exempt transmission and an LBT-required transmission take place at the same time (collide). In this case, the radio base station and/or the user terminal can prioritize one of the LBT-exempt transmission and the LBT-required transmission.

For example, when an LBT-required signal transmission and an LBT-exempt signal transmission take place at the same time, it is preferable if the radio base station and/or the user terminal presume LBT-required transmissions and control the transmissions based on the results of LBT. In this way, by prioritizing LBT-required signal transmissions, it becomes possible to reduce the interference against other systems and so on. Obviously the present embodiment is by no means limited to this.

Also, when there are a plurality of component carriers (or cells), cases might occur where an LBT-exempt transmission and an LBT-required transmission occur at the same time (collide). In this case, it is preferable if the radio base station and/or the user terminal presume LBT-required transmissions and control the transmissions based on the results of LBT. In this way, by prioritizing LBT-required transmissions, it becomes possible to reduce autointerference that is produced when LBT reception and transmission take place at the same time between CCs.

(Structure of Radio Communication System)

Now, the structure of the radio communication system according to the present embodiment will be described below. In this radio communication system, the above-described radio communication methods of the first and second examples are employed. Note that the above-described radio communication methods of the first and second examples may be applied individually or may be applied in combination.

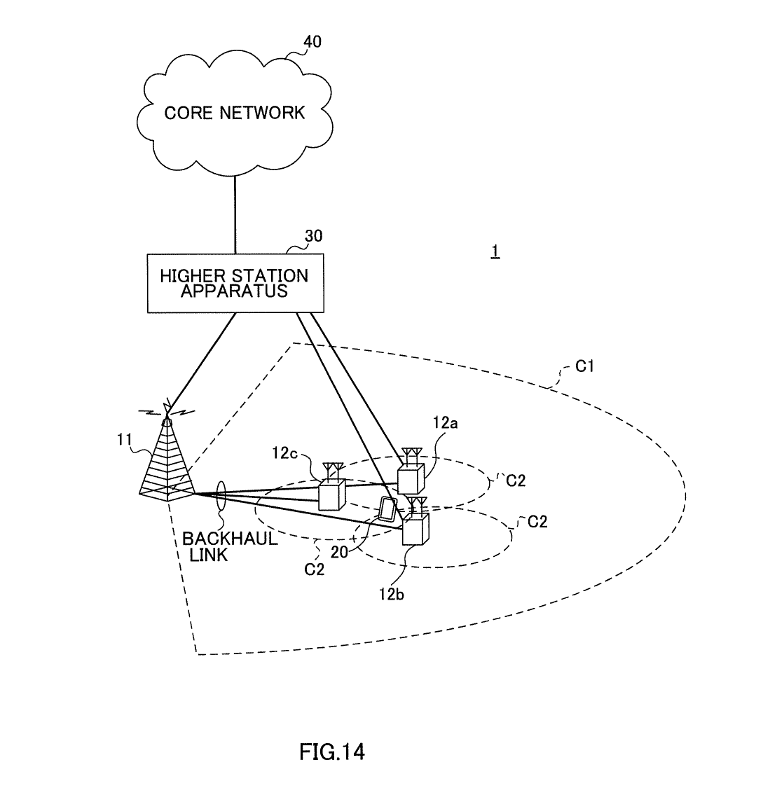

FIG. 14 is a schematic structure diagram of the radio communication system according to the present embodiment. Note that the radio communication system shown in FIG. 14 is, for example, an LTE system, or a system to incorporate SUPER 3G. This radio communication system can adopt carrier aggregation (CA) to group a plurality of fundamental frequency blocks (component carriers) into one, where the LTE system bandwidth constitutes one unit, and/or adopt dual connectivity (DC). Also, the radio communication system shown in FIG. 14 has a licensed band and an unlicensed band (LTE-U base station). Note that this radio communication system may be referred to as “IMT-advanced,” or may be referred to as “4G,” “FRA” (Future Radio Access), etc.

The radio communication system 1 shown in FIG. 14 includes a radio base station 11 that forms a macro cell C1, and radio base stations 12a and 12b that form small cells C2, which are placed within the macro cell C1 and which are narrower than the macro cell C1. Also, user terminals 20 are placed in the macro cell C1 and in each small cell C2. For example, a mode to use the macro cell C1 in the licensed band and use at least one of the small cells C2 in the unlicensed band (LTE-U) may be possible. Also, a mode to use part of the small cells C2, in addition to the macro cell, in the licensed band, and use the other small cells C2 in the unlicensed band may be possible.

The user terminals 20 can connect with both the radio base station 11 and the radio base stations 12. The user terminals 20 can use the macro cell C1 and the small cells C2, which use different frequencies, at the same time, by means of CA or DC. In this case, it is possible to transmit information (assist information) regarding the radio base station 12 that uses the unlicensed band, from the radio base station 11 that uses the licensed band to the user terminals 20. Also, when CA is executed between the licensed band and the unlicensed band, a structure may be employed in which one radio base station (for example, the radio base station 11) controls the scheduling of licensed band cells and unlicensed band cells.

Between the user terminals 20 and the radio base station 11, communication is carried out using a carrier of a relatively low frequency band (for example, 2 GHz) and a narrow bandwidth (referred to as, for example, “existing carrier,” “legacy carrier” and so on). Meanwhile, between the user terminals 20 and the radio base stations 12, a carrier of a relatively high frequency band (for example, 3.5 GHz, 5 GHz and so on) and a wide bandwidth may be used, or the same carrier as that used in the radio base station 11 may be used. Between the radio base station 11 and the radio base stations 12 (or between the radio base stations 12), wire connection (optical fiber, the X2 interface and so on) or wireless connection can be established.

The radio base station 11 and the radio base stations 12 are each connected with a higher station apparatus 30, and are connected with a core network 40 via the higher station apparatus 30. Note that the higher station apparatus 30 may be, for example, an access gateway apparatus, a radio network controller (RNC), a mobility management entity (MME) and so on, but is by no means limited to these. Also, each radio base station 12 may be connected with the higher station apparatus 30 via the radio base station 11.

Note that the radio base station 11 is a radio base station having a relatively wide coverage, and may be referred to as an “eNodeB,” a “macro base station,” a “transmitting/receiving point” and so on. Also, the radio base stations 12 are radio base stations having local coverages, and may be referred to as “small base stations,” “pico base stations,” “femto base stations,” “home eNodeBs,” “RRHs” (Remote Radio Heads), “micro base stations,” “transmitting/receiving points” and so on. Hereinafter the radio base stations 11 and 12 will be collectively referred to as a “radio base station 10,” unless specified otherwise. The user terminals 20 are terminals to support various communication schemes such as LTE, LTE-A and so on, and may be either mobile communication terminals or stationary communication terminals.

In the radio communication system, as radio access schemes, OFDMA (Orthogonal Frequency Division Multiple Access) is applied to the downlink, and SC-FDMA (Single-Carrier Frequency Division Multiple Access) is applied to the uplink. OFDMA is a multi-carrier transmission scheme to perform communication by dividing a frequency band into a plurality of narrow frequency bands (subcarriers) and mapping data to each subcarrier. SC-FDMA is a single-carrier transmission scheme to mitigate interference between terminals by dividing the system band into bands formed with one or continuous resource blocks per terminal, and allowing a plurality of terminals to use mutually different bands.

Here, communication channels to be used in the radio communication system shown in FIG. 14 will be described. Downlink communication channels include a PDSCH (Physical Downlink Shared CHannel), which is used by each user terminal 20 on a shared basis, and downlink L1/L2 control channels (PCFICH, PHICH, PDCCH and enhanced PDCCH). User data and higher control information are communicated by the PDSCH. Scheduling information for the PDSCH and the PUSCH and so on are communicated by the PDCCH (Physical Downlink Control CHannel). The number of OFDM symbols to use for the PDCCH is communicated by the PCFICH (Physical Control Format Indicator CHannel). HARQ ACKs/NACKs for the PUSCH are communicated by the PHICH (Physical Hybrid-ARQ Indicator CHannel). Also, the scheduling information for the PDSCH and the PUSCH and so on may be communicated by the enhanced PDCCH (EPDCCH) as well. This EPDCCH is frequency-division-multiplexed with the PDSCH (downlink shared data channel).

Uplink communication channels include a PUSCH (Physical Uplink Shared CHannel), which is used by each user terminal 20 on a shared basis as an uplink data channel, and a PUCCH (Physical Uplink Control CHannel), which is an uplink control channel. User data and higher control information are communicated by this PUSCH. Also, downlink channel state information (CSI), delivery acknowledgement signals (ACKs/NACKs), scheduling requests (SRs) and so on are communicated by the PUCCH. Note that the channel state information includes radio quality information (CQI), precoding matrix indicators (PMIs), rank indicators (RIs) and so on.

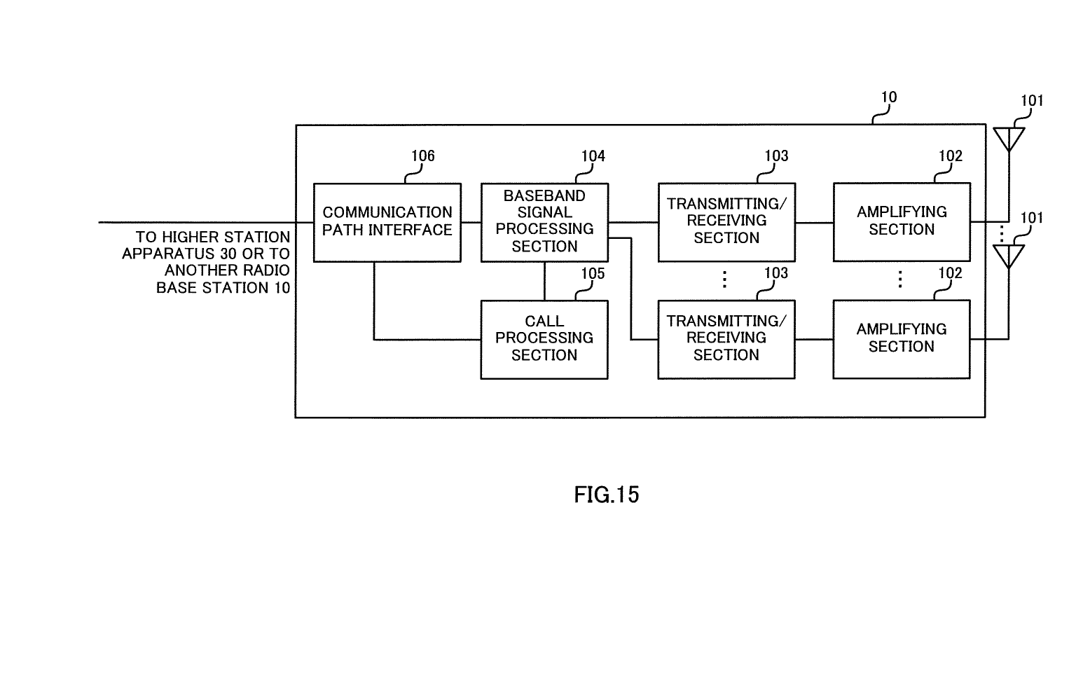

FIG. 15 is a diagram to show an overall structure of a radio base station 10 (which may be either the radio base station 11 or 12) according to the present embodiment. The radio base station 10 has a plurality of transmitting/receiving antennas 101 for MIMO communication, amplifying sections 102, transmitting/receiving sections 103 (transmitting section/receiving section), a baseband signal processing section 104, a call processing section 105 and a communication path interface 106.

User data to be transmitted from the radio base station 10 to a user terminal 20 on the downlink is input from the higher station apparatus 30 to the baseband signal processing section 104, via the communication path interface 106.

In the baseband signal processing section 104, a PDCP layer process, division and coupling of user data, RLC (Radio Link Control) layer transmission processes such as an RLC retransmission control transmission process, MAC (Medium Access Control) retransmission control, including, for example, an HARQ transmission process, scheduling, transport format selection, channel coding, an inverse fast Fourier transform (IFFT) process and a precoding process are performed, and the result is forwarded to each transmitting/receiving section 103. Furthermore, downlink control channel signals are also subjected to transmission processes such as channel coding and an inverse fast Fourier transform, and forwarded to each transmitting/receiving section 103.

Also, the baseband signal processing section 104 reports, to the user terminals 20, control information for allowing communication in the cells, through higher layer signaling (RRC signaling, broadcast information and so on). The information for allowing communication in the cells includes, for example, the uplink or downlink system bandwidth and so on.

Also, from the radio base station 10 to the user terminals, information regarding the DL signals to be transmitted in the unlicensed band can be transmitted. For example, the radio base station 10 can report information about LBT-exempt signals (for example, the transmission cycles, the allocation densities and so on) to the user terminals via the licensed band and/or the unlicensed band.

Each transmitting/receiving section 103 converts the baseband signals, which are pre-coded and output from the baseband signal processing section 104 on a per antenna basis, into a radio frequency band. The amplifying sections 102 amplify the radio frequency signals having been subjected to frequency conversion, and transmit the signals through the transmitting/receiving antennas 101. Note that the transmitting/receiving sections (transmitting section/receiving section) 103 can be transmitters/receivers, transmitting/receiving circuits (transmitting circuit/receiving circuit) or transmitting/receiving devices (transmitting device/receiving device) used in the technical field to which the present invention pertains.

Meanwhile, as for data to be transmitted from the user terminals 20 to the radio base station 10 on the uplink, radio frequency signals that are received in the transmitting/receiving antennas 101 are each amplified in the amplifying sections 102, converted into the baseband signal through frequency conversion in each transmitting/receiving section 103, and input in the baseband signal processing section 104.

In the baseband signal processing section 104, the user data that is included in the input baseband signal is subjected to an FFT process, an IDFT process, error correction decoding, a MAC retransmission control receiving process, and RLC layer and PDCP layer receiving processes, and the result is forwarded to the higher station apparatus 30 via the communication path interface 106. The call processing section 105 performs call processing such as setting up and releasing communication channels, manages the state of the radio base stations 10 and manages the radio resources.

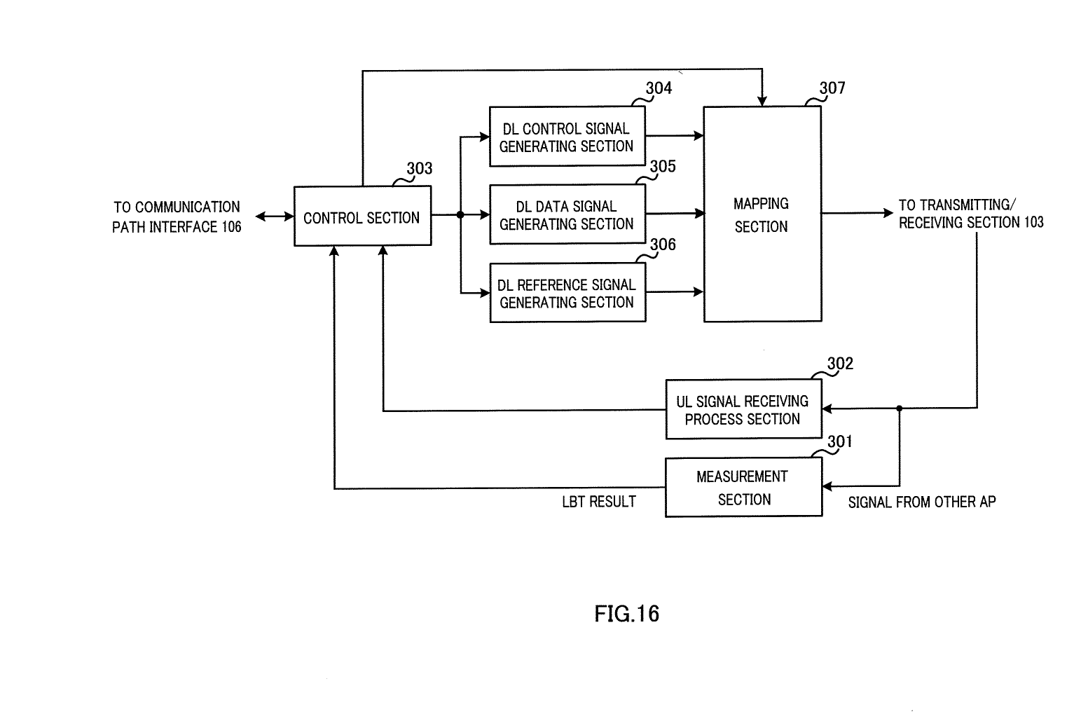

FIG. 16 is a diagram to show a principle functional structure of the baseband signal processing section 104 provided in the radio base station 10 according to the present embodiment. Note that, although FIG. 16 primarily shows function blocks that pertain to characteristic parts of the present embodiment, the radio base station 10 has other function blocks that are necessary for radio communication as well.

As shown in FIG. 16, the radio base station 10 has a measurement section 301, a UL signal receiving process section 302, a control section 303 (scheduler), a DL control signal generating section 304, a DL data signal generating section 305, a DL reference signal generating section 306 and a mapping section (allocation control section) 307.

The measurement section 301 detects/measures (LBT) signals transmitted from other transmission points (APs/TPs) in the unlicensed band. To be more specific, the measurement section 301 detects/measures signals from other transmission points at predetermined timings such as before transmitting DL signals, and outputs the detection/measurement results (LBT results) to the control section 303. For example, if a signal is detected, the measurement section 301 decides whether or not its power level is equal to or higher than a predetermined threshold, and reports the decision (LBT result) to the control section 303. Note that the measurement section 301 can be measurer or a measurement circuit used in the technical field to which the present invention pertains.

The UL signal receiving process section 302 performs receiving processes (for example, the decoding process, demodulation process and so on) of the UL signals (the PUCCH signal, the PUSCH signal and so on) transmitted from the user terminals. Note that the UL signal receiving process section 302 can be a signal processor or a signal processing circuit used in the technical field to which the present invention pertains.

The control section (scheduler) 303 controls the allocations (transmission timings) of downlink data signals that are transmitted in the PDSCH, and downlink control signals (UL grant/DL assignment) that are communicated in the PDCCH and/or the enhanced PDCCH (EPDCCH). Also, the control section 303 controls the allocations (transmission timing) of system information (PBCH), synchronization signals (PSS/SSS) and downlink reference signals (CRS, CSI-RS and so on).

The control section 303 controls the transmissions of DL signals in the unlicensed band based on LBT results output from the measurement section 301. Also, the control section 303 according to the present embodiment controls the transmission of part of the DL signals among a plurality of DL signals, without applying LBT. At this time, the control section 303 may control the transmission power of LBT-exempt signals so that LBT-exempt signals are transmitted with lower transmission power than LBT-required signals.

For example, the control section 303 can configure the transmission cycle of DL signals to be transmitted without applying LBT longer than the transmission cycle used in existing systems (or the licensed band) (see above FIG. 5). Also, the control section 303 can configure the allocation density of DL signals to be transmitted without applying LBT in the time direction lower than the allocation density used in existing systems (or the licensed band) (see above FIG. 6).

Also, the control section 303 can control a plurality of DL signals (for example, two or more signals selected from the synchronization signals, broadcast signal, cell-specific reference signals and channel measurement reference signals) to be allocated to predetermined subframes as LBT-exempt signals (see above FIG. 7). When doing so, the control section 303 can control all the DL signals (the PDSCH signal, the PDCCH signal and so on) that are allocated to predetermined subframes to be transmitted without applying LBT (see above FIG. 8). Also, when there are DL signals of the same type (for example, CRSs), the control section 303 may configure subframes that are transmitted by using LBT and subframes that are transmitted without using LBT.

Note that, with the present embodiment, it is possible to perform LBT in the measurement section 301 on the user terminal side (UL transmission side), and control the transmission of UL signals (determine whether or not transmission is possible) in the control section 303 based on the results of LBT. Note that the control section 303 can be a controller, a scheduler, a control circuit or a control device used in the technical field to which the present invention pertains.

The DL control signal generating section 304 generates DL control signals (the PDCCH signal, the EPDCCH signal, the PSS/SSS signals, the PBCH signal and so on) based on commands from the control section 303. To be more specific, when an LBT result output from the measurement section 301 renders a decision that a DL signal can be transmitted, the DL control signal generating section 304 generates a DL control signal. On the other hand, when an LBT result output from the measurement section 301 renders a decision that a DL signal cannot be transmitted, the DL control signal generating section 304 generates an LBT-exempt signal, but does not generate an LBT-required signal.

The downlink data signal generating section 305 generates downlink data signals (PDSCH signals). The downlink reference signal generating section 306 generates downlink reference signals (the CRS, the CSI-RS, the DM-RS, etc.). The DL data signal generating section 305 and the DL reference signal generating section 306 generate LBT-exempt signals and LBT-required signals based on commands from the control section 303. Note that the DL control signal generating section 304, the DL data signal generating section 305 and the DL reference signal generating section 306 can be signal generating devices or signal generating circuits used in the technical field to which the present invention pertains.

Also, the mapping section (allocation control section) 307 controls the mapping (allocation) of DL signals based on commands from the control section 303. To be more specific, when an LBT result output from the measurement section 301 renders a decision that a DL signal can be transmitted, the mapping section 307 allocates the DL signal. On the other hand, when an LBT result output from the measurement section 301 renders a decision that a DL signal cannot be transmitted, the mapping section 307 maps an LBT-exempt signal to a predetermined subframe, but does not map an LBT-required signal. Note that the mapping section 307 can be a mapping circuit or a mapper used in the technical field to which the present invention pertains.

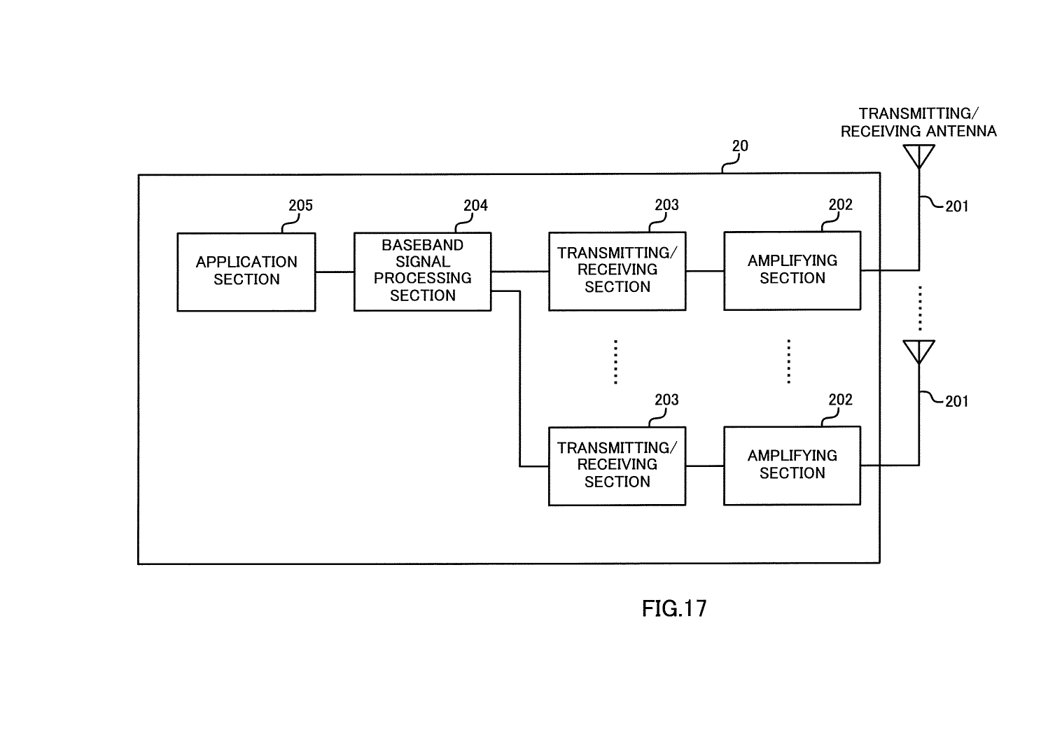

FIG. 17 is a diagram to show an overall structure of a user terminal 20 according to the present embodiment. The user terminal 20 has a plurality of transmitting/receiving antennas 201 for MIMO communication, amplifying sections 202, transmitting/receiving sections 203 (transmitting section/receiving section), a baseband signal processing section 204 and an application section 205.

As for downlink data, radio frequency signals that are received in a plurality of transmitting/receiving antennas 201 are each amplified in the amplifying sections 202, and subjected to frequency conversion and converted into the baseband signal in the transmitting/receiving sections 203. This baseband signal is subjected to receiving processes such as an FFT process, error correction decoding and retransmission control (HARQ-ACK) in the baseband signal processing section 204. In this downlink data, downlink user data is forwarded to the application section 205. The application section 205 performs processes related to higher layers above the physical layer and the MAC layer. Furthermore, in the downlink data, broadcast information is also forwarded to the application section 205.

Meanwhile, uplink user data is input from the application section 205 to the baseband signal processing section 204. In the baseband signal processing section 204, a retransmission control (HARQ-ACK) transmission process, channel coding, precoding, a DFT process, an IFFT process and so on are performed, and the result is forwarded to each transmitting/receiving section 203. The baseband signal that is output from the baseband signal processing section 204 is converted into a radio frequency band in the transmitting/receiving sections 203. After that, the amplifying sections 202 amplify the radio frequency signal having been subjected to frequency conversion, and transmit the resulting signal from the transmitting/receiving antennas 201. Note that the transmitting/receiving sections (transmitting section/receiving section) 203 can be transmitters/receivers, transmitting/receiving circuits (transmitting circuit/receiving circuit) or transmitting/receiving devices (transmitting device/receiving device) used in the technical field to which the present invention pertains.

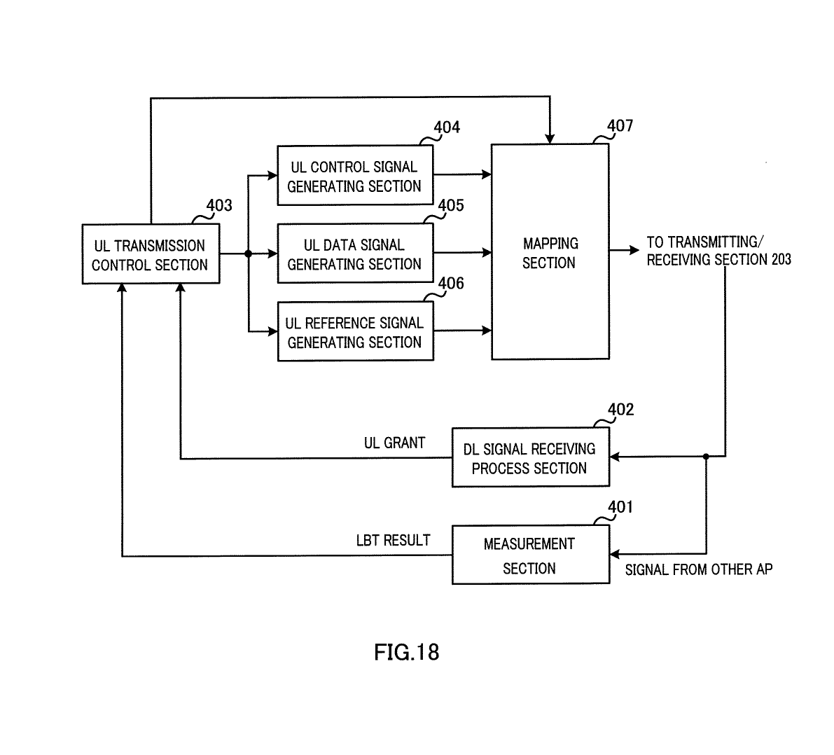

FIG. 18 is a diagram to show a principle functional structure of the baseband signal processing section 204 provided in the user terminal 20. Note that, although FIG. 18 primarily shows function blocks that pertain to characteristic parts of the present embodiment, the user terminal 20 has other function blocks that are necessary for radio communication as well.

As shown in FIG. 18, the user terminal 20 has a measurement section 401, a DL signal receiving process section 402, a UL transmission control section 403 (control section), a UL control signal generating section 404, a UL data signal generating section 405, a UL reference signal generating section 406 and a mapping section 407. Note that, when LBT in UL commination is performed on the radio base station side, the measurement section 401 can be removed.

The measurement section 401 detects/measures (LBT) signals transmitted from other transmission points (APs/TPs) in the unlicensed band. To be more specific, the measurement section 401 detects/measures signals from other transmission points at predetermined timings such as before transmitting UL signals, and outputs the detection/measurement results (LBT results) to the UL transmission control section 403. For example, if a signal is detected, the measurement section 401 decides whether or not its power level is equal to or higher than a predetermined threshold, and reports the decision (LBT result) to the UL transmission control section 403. Note that measurement section 401 can be a measurer or a measurement circuit used in the technical field to which the present invention pertains.

The DL signal receiving process section 402 performs receiving processes (for example, the decoding process, the demodulation process and so on) for the DL signals transmitted in the licensed band or the unlicensed band. For example, the DL signal receiving process section 402 acquires a UL grant that is included in downlink control signals (for example, DCI formats 0 and 4) and outputs this to the UL transmission control section 403.

When LBT-exempt signals are transmitted from the radio base station, the DL signal receiving process section 402 can detect the LBT-exempt signals (reference signals, broadcast information and so on) in a predetermined cycle based on information about the LBT-exempt signals reported from the radio base station 10 or stipulated in the specification. Also, since LBT-exempt signals are transmitted regardless of the results of LBT, the DL signal receiving process section 402 performs receiving operations on the assumption that these signals are transmitted in LBT-exempt signal cycles that have been acquired in advance. Note that the DL signal receiving process section 402 can be a signal processor or a signal processing circuit used in the technical field to which the present invention pertains.

The UL transmission control section 403 controls the transmissions of UL signals (UL data signals, UL control signals, reference signals and so on) for the radio base station in the licensed band and the unlicensed band. Also, the UL transmission control section 403 controls the transmissions in the unlicensed band based on the detection/measurement results (LBT results) from the measurement section 401. That is, by taking into consideration the UL transmission commands (UL grants) transmitted from the radio base station and the detection results (LBT results) from the measurement section 401, the UL transmission control section 403 controls the transmissions of UL signals in the unlicensed band.

The UL transmission control section 403 controls the transmissions of UL signals in the unlicensed band based on the LBT results output from the measurement section 401. Also, the UL transmission control section 403 according to the present embodiment controls the transmission of part of the UL signals among a plurality of UL signals, without applying LBT (as LBT-exempt signals). At this time, the UL transmission control section 403 may control the transmission power of LBT-exempt signals so that LBT-exempt signals are transmitted with lower transmission power than LBT-required signals.

For example, the UL transmission control section 403 can configure the transmission cycle of UL signals to be transmitted without applying LBT longer than the transmission cycle used in existing systems (or the licensed band). [0169] Also, the UL transmission control section 403 can control a plurality of DL signals (for example, two or more signals selected from the PRACH signal, the SRS and the PUCCH signal) to be allocated to predetermined subframes as LBT-exempt signals (see above FIG. 12). When doing so, the UL transmission control section 403 can control all the UL signals (the PUSCH signal, the DM-RS and so on) that are allocated to predetermined subframes to be transmitted without applying LBT (see above FIG. 13). Also, when there are UL signals of the same type (for example, SRSs), the UL transmission control section 403 may configure subframes that are transmitted by using LBT and subframes that are transmitted without using LBT. Note that the UL transmission control section 403 can be a control circuit or a control device used in the technical field to which the present invention pertains.

The UL control signal generating section 404 generates UL control signals (the PUCCH signal, the PRACH signal and so on) based on commands from the UL transmission control section 403. To be more specific, when an LBT result output from the measurement section 401 renders a decision that a UL signal can be transmitted, the UL control signal generating section 404 generates a UL control signal. On the other hand, when an LBT result output from the measurement section 401 renders a decision that a UL signal cannot be transmitted, the UL control signal generating section 404 generates an LBT-exempt signal, but does not generate an LBT-required signal.

The UL data signal generating section 405 generates UL data signals (PUSCH signals) based on UL grants transmitted from the radio base station. Also, the UL reference signal generating section 406 generates reference signals (the SRS, the DM-RS and so on). The UL data signal generating section 405 and the UL reference signal generating section 406 also generate LBT-exempt signals and LBT-required signals based on commands from the UL transmission control section 403. Note that the UL control signal generating section 404, the UL data signal generating section 405 and the UL reference signal generating section 406 can be signal generating devices or signal generating circuits used in the technical field to which the present invention pertains.

Also, the mapping section (allocation control section) 407 controls the mapping (allocation) of UL signals based on commands from the UL transmission control section 403. To be more specific, when an LBT result output from the measurement section 401 renders a decision that a UL signal can be transmitted, the mapping section 407 allocates the UL signal. On the other hand, when an LBT result output from the measurement section 401 renders a decision that a UL signal cannot be transmitted, the mapping section 407 maps an LBT-exempt signal to a predetermined subframe, but does not map an LBT-required signal. Note that the mapping section 407 can be a mapping circuit or a mapper used in the technical field to which the present invention pertains.

As described above, according to the present embodiment, the transmissions of predetermined DL signals and/or UL signals are controlled without applying LBT (regardless of the results of LBT). By this means, important signals can be transmitted reliably regardless of the results of LBT, it is possible to prevent the deterioration of signal quality that arises due to signal delays, signal disconnections, cell detection failures and so on. Also, by configuring the transmission cycle and so on of LBT-exempt signals longer than the transmission cycle and so on in existing systems (or licensed bands), it is possible to reduce the overhead of LBT-exempt signals and reduce the interference against other cells, and, furthermore, keep transmitting LBT-exempt signals regardless of the results of LBT.

Note that, although a case has been described above in which an unlicensed band cell controls whether or not DL signals can be transmitted based on LBT results, the present embodiment is by no means limited to this. For example, the present embodiment is equally applicable to cases where, depending on the result of LBT, transitions are made to other carriers by DFS (Dynamic Frequency Selection), transmission power control (TPC) is applied, and so on.

Now, although the present invention has been described in detail with reference to the above embodiment, it should be obvious to a person skilled in the art that the present invention is by no means limited to the embodiment described herein. The present invention can be implemented with various corrections and in various modifications, without departing from the spirit and scope of the present invention defined by the recitations of claims. For example, a plurality of examples described above may be combined and implemented as appropriate. Consequently, the description herein is only provided for the purpose of illustrating examples, and should by no means be construed to limit the present invention in any way.

The disclosure of Japanese Patent Application No. 2014-143218, filed on Jul. 11, 2014, including the specification, drawings and abstract, is incorporated herein by reference in its entirety.

1. A radio base station that communicates with a user terminal that is capable of using a licensed band and an unlicensed band, the radio base station comprising:
a transmission section that transmits a plurality of DL signals in the unlicensed band; and
a control section that controls transmission of the DL signals in the unlicensed band based on results of LBT (Listen Before Talk),
wherein the control section controls transmission of part of the DL signals among the plurality of DL signals without applying LBT.

2. The radio base station according to claim 1, wherein the control section configures a transmission cycle of a DL signal that is transmitted without applying LBT longer than a transmission cycle that is applied to the DL signal in an existing system.

3. The radio base station according to claim 1, wherein the control section configures an allocation density of a DL signal that is transmitted without applying LBT in a time direction lower than an allocation density that is applied in an existing system.

4. The radio base station according to claim 3, wherein the transmission section transmits information about the transmission cycle of the DL signal that is transmitted without applying LBT and/or the allocation density in the time direction to the user terminal.

5. The radio base station according to claim 1, wherein the control section controls a plurality of DL signals that are transmitted without applying LBT to be allocated to predetermined subframes.

6. The radio base station according to claim 5, wherein the control section controls all DL signals that are allocated to the predetermined subframes to be transmitted without applying LBT.

7. The radio base station according to claim 1, wherein the DL signals that are transmitted without applying LBT include at least one of a synchronization signal, a broadcast signal, a cell-specific reference signal and a channel measurement reference signal.

8. The radio base station according to claim 1, wherein, when there are DL signals of a same type, the control section configures a subframe that is transmitted by using LBT and a subframe that is transmitted without using LBT.

9. A user terminal that is capable of communicating with a radio base station by using a licensed band and an unlicensed band, the user terminal comprising:
a transmission section that transmits a plurality of UL signals in the unlicensed band; and
a transmission control section that controls transmission of the UL signal in the unlicensed band based on results of LBT (Listen Before Talk),
wherein the transmission control section controls transmission of part of the UL signals among the plurality of UL signals regardless of the results of LBT.

10. A radio communication method for a radio base station that connects with a user terminal by using a licensed band and an unlicensed band, the radio communication method comprising, in the radio base station, the steps of:
transmitting a plurality of DL signals in the unlicensed band; and
controlling transmission of the DL signals in the unlicensed band by using LBT (Listen Before Talk),
wherein part of the DL signals among the plurality of DL signals are transmitted without applying LBT.

11. The radio base station according to claim 2, wherein the DL signals that are transmitted without applying LBT include at least one of a synchronization signal, a broadcast signal, a cell-specific reference signal and a channel measurement reference signal.

12. The radio base station according to claim 3, wherein the DL signals that are transmitted without applying LBT include at least one of a synchronization signal, a broadcast signal, a cell-specific reference signal and a channel measurement reference signal.

13. The radio base station according to claim 4, wherein the DL signals that are transmitted without applying LBT include at least one of a synchronization signal, a broadcast signal, a cell-specific reference signal and a channel measurement reference signal.

14. The radio base station according to claim 5, wherein the DL signals that are transmitted without applying LBT include at least one of a synchronization signal, a broadcast signal, a cell-specific reference signal and a channel measurement reference signal.

15. The radio base station according to claim 6, wherein the DL signals that are transmitted without applying LBT include at least one of a synchronization signal, a broadcast signal, a cell-specific reference signal and a channel measurement reference signal.

16. The radio base station according to claim 2, wherein the control section configures an allocation density of a DL signal that is transmitted without applying LBT in a time direction lower than an allocation density that is applied in an existing system.
